(19) United States
(12) Patent Application Publication
(10) Pub. No.: US 2026/0330150 A1
(43) Pub. Date: Oct. 22, 2026

(54) LARGE VISION AND LANGUAGE MODELS WITH A PANEL OF PEERS

(71) Applicant: ADOBE INC., SAN JOSE, CA (US)

(72) Inventors: Jefferson Hernandez, Houston, TX (US); Jing Shi, San Jose, CA (US); Simon Jenni, Hagendorf (CH); Kushal Kafle, Sunnyvale, CA (US)

(21) Appl. No.: 19/185,848

(22) Filed: Apr. 22, 2025

(51) Int. Cl. G06F 40/40

(52) U.S. Cl. CPC G06F 40/40

(57) ABSTRACT

A method, apparatus, non-transitory computer readable medium, and system for video generation includes obtaining a dataset including an input prompt. A panel-of-peers model generate response data based on the input prompt, wherein the response data includes a first response generated by a first language generation model of the panel-of-peers model and a second response generated by a second language generation model of the panel-of-peers model that is different from the first language generation model. The panel-of-peers model generate evaluation data based on the response data, wherein the evaluation data includes a first evaluation of the first response and a second evaluation of the second response, wherein the first evaluation is generated by the second language generation model and the second evaluation is generated by the first language generation model. The panel-of-peers model are trained based on the evaluation data.

### BACKGROUND

The following generally relates to machine learning, and more specifically to response generation using a machine learning model. Machine learning algorithms build a model based on sample data, known as training data, to make a prediction or a decision in response to an input without being explicitly programmed to do so. One area of application for machine learning is generating response to a user query.

For example, a machine learning model can be trained to integrate and process visual and textual data for various tasks such as image captioning, visual question answering, and multimodal reasoning. In some cases, the models leverage deep learning architectures to align features from visual and linguistic modalities effectively. Such response generation mechanism provides for a user to receive a response based on analyzing an input image or text-based information and therefore efficiently generates a coherent response.

### SUMMARY

The present disclosure describes systems and methods for language processing, more specifically to response generation. Embodiments of the present disclosure include a language processing apparatus comprising a plurality of language generation models as panel-of-peers model. In some cases, each of the plurality of language generation models are configured to generate synthetic data for performing an autonomous self-improvement process. For example, the language processing apparatus is configured to fine-tune each of the plurality of language generation models using the synthetic data based on an iterative interaction among the language generation models of the panel-of-peers model.

A method, apparatus, and non-transitory computer readable medium for language processing apparatus are described. One or more aspects of the method, apparatus, and non-transitory computer readable medium include obtaining a dataset including an input prompt; generating, using a panel-of-peers model, response data based on the input prompt, wherein the response data includes a first response generated by a first language generation model of the panel-of-peers model and a second response generated by a second language generation model of the panel-of-peers model that is different from the first language generation model; generating, using the panel-of-peers model, evaluation data based on the response data, wherein the evaluation data includes a first evaluation of the first response and a second evaluation of the second response, wherein the first evaluation is generated by the second language generation model and the second evaluation is generated by the first language generation model; and training the panel-of-peers model based on the evaluation data.

A method, apparatus, and non-transitory computer readable medium for language processing apparatus are described. One or more aspects of the method, apparatus, and non-transitory computer readable medium include obtaining a dataset including an input prompt comprising an image and a query about the image; generating, using a panel-of-peers model, response data based on the input prompt, wherein the response data includes a first response to the query generated by a first language generation model of the panel-of-peers model and a second response to the query generated by a second language generation model of the panel-of-peers model; and training the panel-of-peers model to respond to the query about the image based on the response data.

An apparatus and system for language processing apparatus are described. One or more aspects of the apparatus and system include a memory component; a processing device coupled to the memory component, the processing device configured to perform operations comprising: obtaining a dataset including an input prompt; generating, using a panel-of-peers model, response data based on the input prompt, wherein the response data includes a first response generated by a first language generation model of the panel-of-peers model and a second response generated by a second language generation model of the panel-of-peers model that is different from the first language generation model; generating, using the panel-of-peers model, evaluation data based on the response data, wherein the evaluation data includes a first evaluation of the first response and a second evaluation of the second response, wherein the first evaluation is generated by the second language generation model and the second evaluation is generated by the first language generation model; and training the panel-of-peers model based on the evaluation data.

### BRIEF DESCRIPTION OF THE DRAWINGS

FIG. 1 shows an example of a language processing system according to aspects of the present disclosure.

FIG. 2 shows an example of a method for response generation according to aspects of the present disclosure.

FIG. 3 shows an example of a response generation process for a vision centric task according to aspects of the present disclosure.

FIG. 4 shows an example of a response generation process for a general visual question answering (VQA) according to aspects of the present disclosure.

FIG. 5 shows an example of a response generation framework according to aspects of the present disclosure.

FIG. 6 shows an example of a large vision-language model according to aspects of the present disclosure.

FIG. 7 shows an example of a transformer network according to aspects of the present disclosure.

FIG. 8 shows an example of a method for language processing apparatus according to aspects of the present disclosure.

FIG. 9 shows an example of a framework for training the panel-of-peers model according to aspects of the present disclosure.

FIG. 10 shows an example of a method of training a machine learning model according to aspects of the present disclosure.

FIG. 11 shows an example of a computing device according to aspects of the present disclosure.

FIG. 12 shows an example of a language processing apparatus according to aspects of the present disclosure.

### DETAILED DESCRIPTION

The present disclosure describes systems and methods for language processing, more specifically to response generation. Embodiments of the present disclosure include a response generation apparatus comprising a plurality of machine learning models (i.e., language generation models) as a panel-of-peers model. In some cases, each of the plurality of language generation models is configured to generate synthetic data for performing an autonomous self-improvement process. For example, the language processing apparatus is configured to fine-tune each of the plurality of language generation models using the synthetic data based on an iterative interaction among the language generation models of the panel-of-peers model.

Existing response generation systems are used to perform diverse operations including compositional reasoning, use of general knowledge, pictorial reasoning, etc. In some cases, the response generation systems used in the existing art rely on human preference data for performing model fine-tuning. Additionally, in some cases, existing systems are unable to generate a response that is accurately aligned with the expectations of the user.

Moreover, some existing response generation systems are unable to generate responses that are aligned with the user intent and reliable. In some examples, an existing system is trained on domain-specific data to enhance generation performance on different downstream tasks. However, such systems face challenges, such as hallucination issues, misalignment between visual and textual representations, and knowledge gaps. Additionally, existing response generation systems use low-quality, large-scale manually annotated image-text pairs. As a result, such systems depict limited performance and are associated with a large number of resources.

By contrast, embodiments of the present disclosure are configured to perform the response generation based on a query without using a corresponding response associated with the query. In some cases, the language processing apparatus of the present disclosure is configured to enable learning of a language generation model based on a peer-to-peer feedback method. For example, the language generation model is a large vision-language model. In some examples, the peer-to-peer feedback method comprises learning based on panel-of-peers model. In some examples, the panel-of-peers model comprise a plurality of language generation models.

The present disclosure describes systems and methods for response generation. Embodiments of the present disclosure include a language processing apparatus configured to generate a panel-of-peers model comprising a plurality of language generation models. In some examples, each language generation model of the plurality of language generation models comprises a similar base model. In some examples, each language generation model of the plurality of language generation models is trained using a similar (e.g., same) training dataset.

Embodiments of the present disclosure include a language processing apparatus configured to perform a self-improvement process based on an interaction between the plurality of language generation models. In some cases, each language generation model of the plurality of language generation models in the panel-of-peers model is configured to generate a candidate response for an input prompt. For example, the language generation model generates the candidate response for a dataset of input prompts. In some examples, the language processing apparatus is configured to provide the input prompt (i.e., input prompt provided without a ground-truth response to the prompt). In some cases, each of the other language generation model of the plurality of language generation models in the panel-of-peers model is configured to evaluate the candidate response.

Embodiments of the present disclosure include a language processing apparatus configured to generate a reward score. In some cases, language processing apparatus evaluates the candidate response based on a plurality of metrics. For example, the metrics used to evaluate the candidate response include, but are not limited to, helpfulness, correctness, verbosity, coherence, and complexity. In some examples, the language processing apparatus is used to generate a preliminary score by performing the evaluation based on a psychometric tool (such as a Likert scale) that rates the candidate responses using the said metrics.

In some cases, the language processing apparatus combines the preliminary score to generate the reward score based on a reward ensemble method. In some cases, the language processing apparatus generates a preference response dataset using the reward score. For example, the language processing apparatus uses the preference response dataset to fine-tune each language generation model of the plurality of language generation models in the panel-of-peers model.

An embodiment of the present disclosure includes a language processing apparatus configured to perform learning from panel-of-peers model. In some cases, the learning from the panel-of-peers model implements a self-improvement paradigm for enhancing response generation capability of a plurality of language generation models in the panel-of-peers model. According to an embodiment, the language processing apparatus implements learning from the panel-of-peers model to enable knowledge transfer among the language generation models in the panel-of-peers model.

As described herein, an input prompt refers to an input to a machine learning model, An input prompt includes an input query and an input image. For example, an input prompt can comprise a query related to Math and Science (such as related to solving an equation). In some examples, an input prompt can comprise a vision centric query, such as an input image (e.g., depicting a parking lot with multiple cars) and an associated query (e.g., “Which spot is the red car parking on?”). Additionally, for example, an input prompt can comprise a general visual question answering task.

As described herein, a panel-of-peers model refer to an ensemble of multiple models, such as multiple language generation models that depict similar network capacity and performance. In some cases, the multiple language generation models of the panel-of-peers model are trained on the same training dataset. For instance, the multiple language generation models of the panel-of-peers model are distinct from each other since some models can have a high performance in a task than another similar language generation model. In some examples, the language generation model can refer to a large vision-language model (LVLM).

The term language generation model may refer to a machine learning-based model configured to generate responses (including text-based or image-based responses) based on input data. The language generation model may utilize deep learning architectures, such as transformer-based neural networks, recurrent neural networks (RNNs), or other sequence-processing models, to generate contextually relevant and semantically coherent output. The model may be trained on a corpus of data including structured and unstructured data.

In some cases, the language generation model can be a vision-language model (VLM) or a multi-modal large language model (MLLM). In some aspects, when the type of language generation model is a vision-language model, the language generation model can have images as input or output. In some aspects, when the type of language generation model is a vision-language model, the language generation model can have text and images as input or output.

As described herein, a response data comprises candidate responses generated by each language generation model of the panel-of-peers model. For instance, each language generation model (i.e., a machine learning model) generates a candidate response for a dataset of input prompts (a ground-truth response is not provided to the language generation model). The language generation model generates a plurality of candidate responses in multiple tries.

Each language generation model evaluates an accuracy of each of the other language generation models using a reward score. Each language generation model computes the reward score based on calculating at least one of an average, a minimum, or an uncertainty weight associated with all the candidate responses. The reward score is used to select evaluation data from the candidate response and use the evaluation data for fine-tuning the language generation models in the panel-of-peers model.

Accordingly, by incorporating feedback from each machine learning model of the plurality of machine learning models in the panel-of-peers model, embodiments of the present disclosure are able to augment performance of each machine learning model for a downstream task. Additionally, by performing knowledge transfer among the plurality of machine learning models of the panel-of-peers model, embodiments enable learning for an unseen task by a machine learning model (e.g., a member of the panel of peers) when a different machine learning model possesses that knowledge.

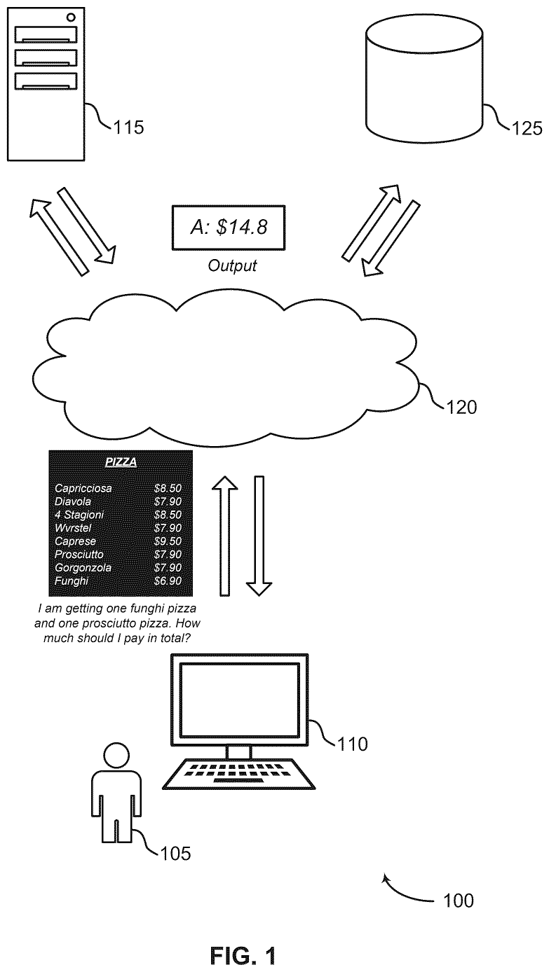

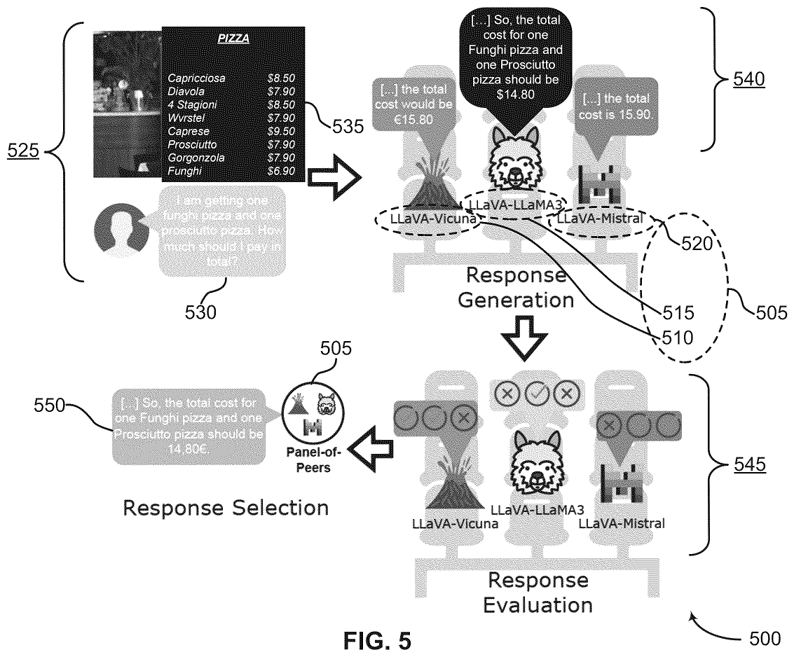

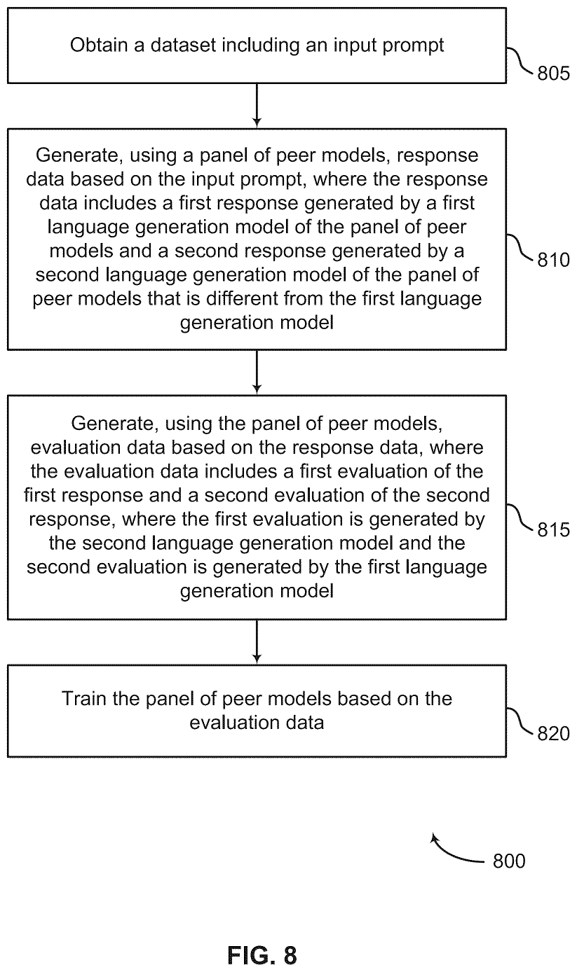

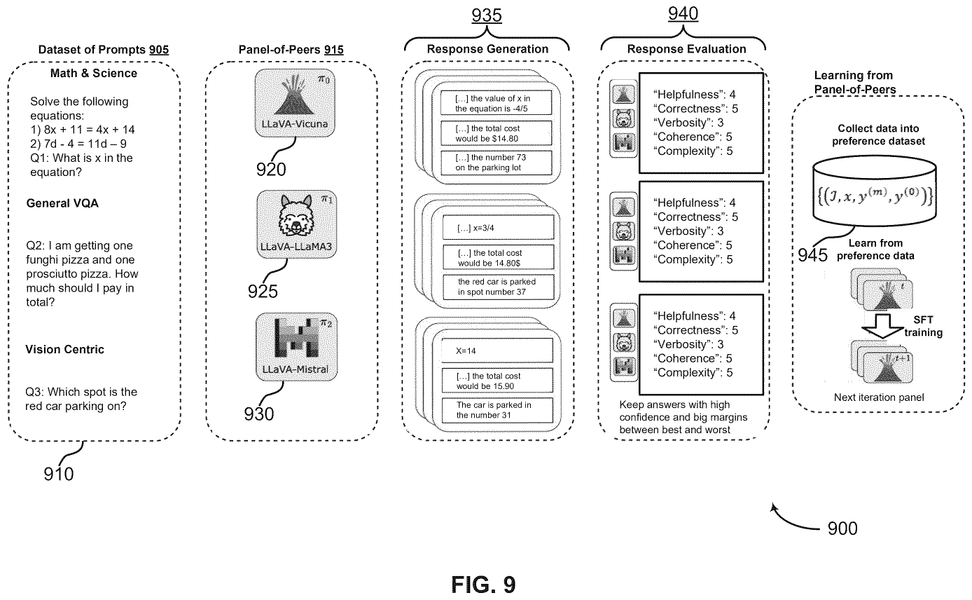

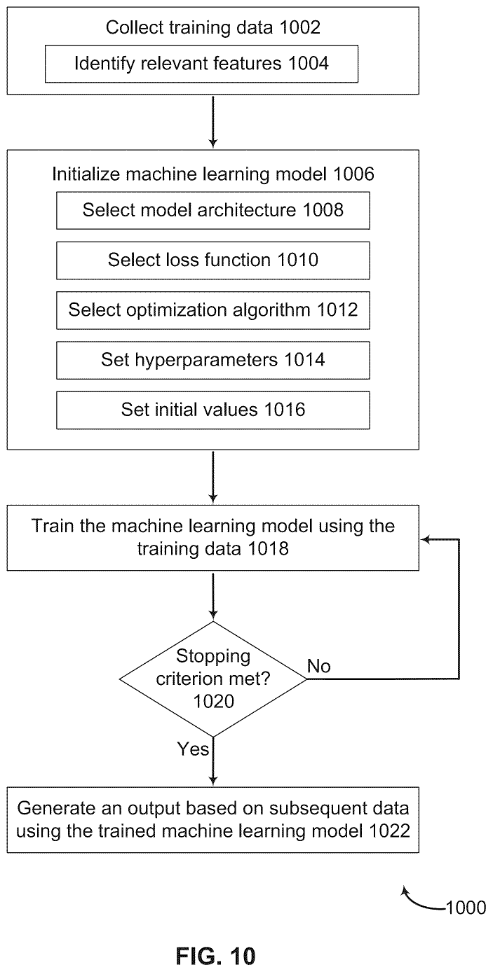

Embodiments of the present disclosure can be implemented in a language processing system. For example, the language processing system based on the present disclosure takes an input prompt (e.g., describing a query) and generates a response that accurately answers the query provided by the input prompt. Example applications regarding generating a response are provided with reference to FIGS. 1-4. Details regarding the architecture of the panel-of-peers model are provided with reference to FIGS. 5-7 and 11-12. Details regarding an operation of the panel-of-peers model are provided with reference to FIG. 8. Examples of a process for training the panel-of-peers model are provided with reference to FIGS. 9-10.

### Response Generation System

A system and an apparatus for language processing are described with reference to FIGS. 1-8. FIG. 1 shows an example of a language processing system 100 according to aspects of the present disclosure. In one aspect, language processing system 100 includes user 105, user device 110, language processing apparatus 115, cloud 120, and database 125.

In the example of FIG. 1, user provides a prompt with a visual query (e.g., an image) to language processing apparatus 115 via a user interface provided on user device 110 by language processing apparatus 115. In some examples, the input prompt refers to visual question answering. As shown in FIG. 1, the input prompt comprises a query and an associated image based on which the user wants to generate a response using the language processing apparatus 115 of the present disclosure.

In some cases, the language processing apparatus 115 implements a panel-of-peers model (such as the panel-of-peers model described with reference to FIGS. 5-7 and 8-9) to generate a response that answers the query based on the image provided in the input prompt. For example, as shown in FIG. 1, the user provides an input prompt (e.g., a text query and an associated image) to the language processing apparatus 115, for which the user wants to generate a response. In some examples, the language processing apparatus 115 generates a response that accurately aligns with the information provided by the input prompt.

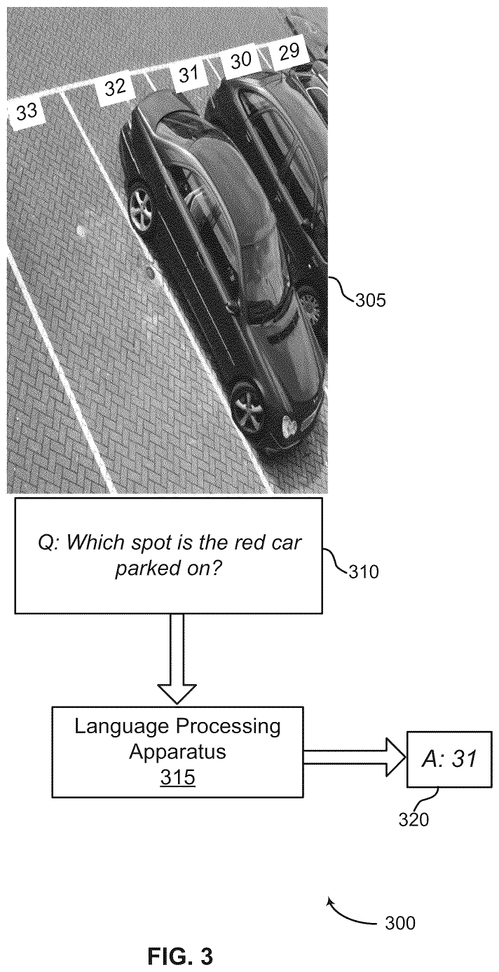

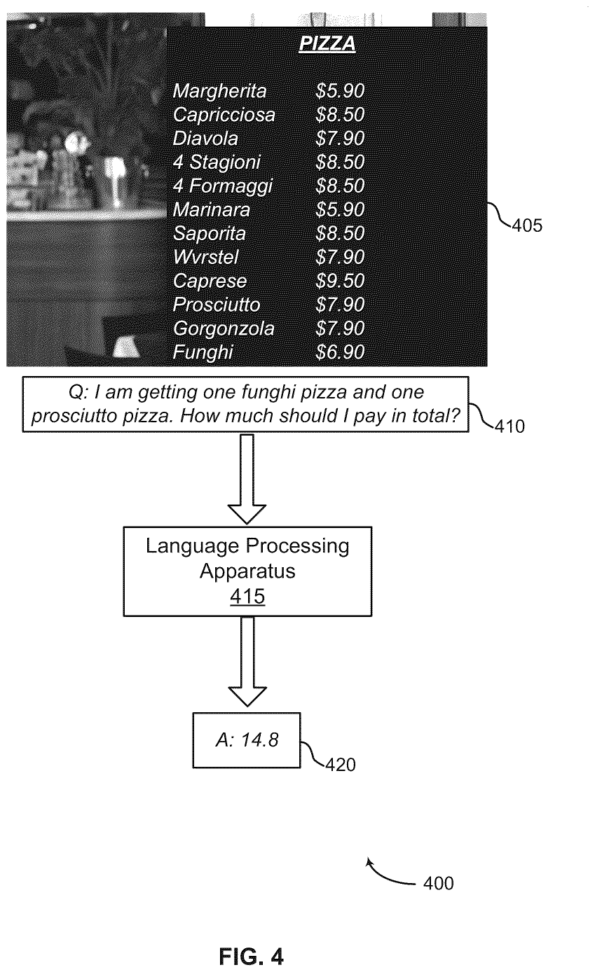

In some examples, the language processing apparatus 115 comprises a plurality of machine learning models as a panel of peers (e.g., the panel-of-peers model). In some cases, each of the plurality of machine learning models generates synthetic response data for performing an autonomous self-improvement of each of the other machine learning models in the panel-of-peers model. Subsequently, the improved machine learning models in the panel-of-peers model generate responses that are accurate, coherent, and helpful for the user. Language processing apparatus 115 is an example of, or includes aspects of, the corresponding element described with reference to FIGS. 3 and 4.

Referring again to the example of FIG. 1, the language processing apparatus 115 generates the response that accurately answers a query provided by the input prompt. According to some aspects, user device 110 is a personal computer, laptop computer, mainframe computer, palmtop computer, personal assistant, mobile device, or any other suitable processing apparatus. In some examples, user device 110 includes software that displays a user interface (e.g., a graphical user interface) provided by language processing apparatus 115. In some aspects, the user interface provides for information (such as text, images (an input image or an input query), video, a prompt, a canvas, etc.) to be communicated between user 105 and language processing apparatus 115.

According to some aspects, a user device user interface enables user 105 to interact with user device 110. In some embodiments, the user device user interface may include an audio device, such as an external speaker system, an external display device such as a display screen, or an input device (e.g., a remote-control device interfaced with the user interface directly or through an I/O controller module). In some cases, the user device user interface may be a graphical user interface.

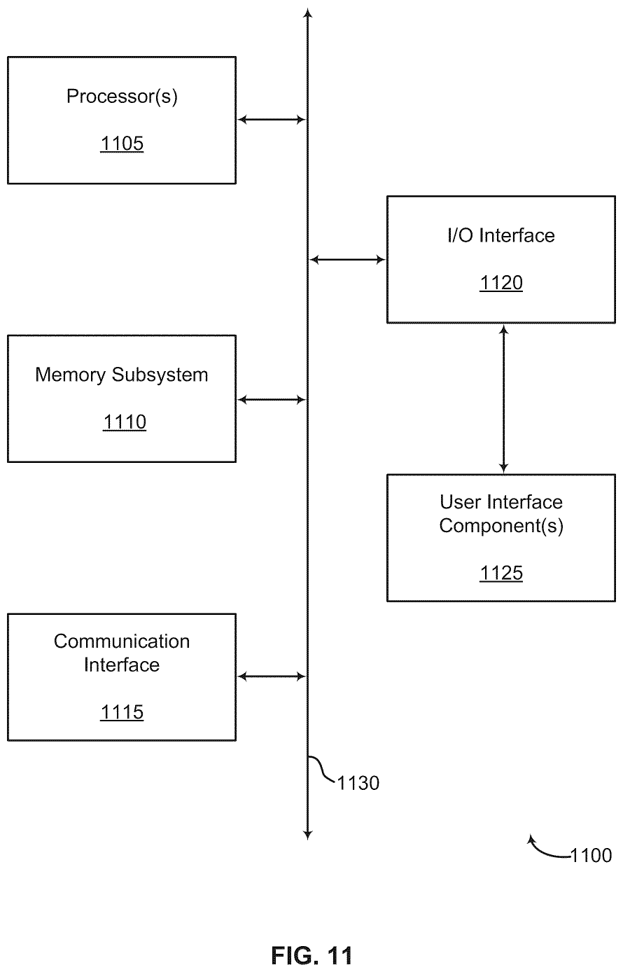

According to some aspects, language processing apparatus 115 includes a computer-implemented network. In some embodiments, the computer-implemented network includes a panel-of-peers model (such as the panel-of-peers model described with reference to at least FIGS. 5-7). In some embodiments, language processing apparatus 115 also includes one or more processors, a memory subsystem, a communication interface, an I/O interface, one or more user interface components, and a bus as described with reference to FIG. 11. Additionally, in some embodiments, language processing apparatus 115 communicates with user device 110 and database 125 via cloud 120.

In some cases, language processing apparatus 115 is implemented on a server. A server provides one or more functions to users linked by way of one or more of various networks, such as cloud 120. In some cases, the server includes a single microprocessor board, which includes a microprocessor responsible for controlling all aspects of the server. In some cases, the server uses microprocessor and protocols to exchange data with other devices or users on one or more of the networks via hypertext transfer protocol (HTTP), and simple mail transfer protocol (SMTP), although other protocols such as file transfer protocol (FTP), and simple network management protocol (SN MP) may also be used. In some cases, the server is configured to send and receive hypertext markup language (HTML) formatted files (e.g., for displaying web pages). In various embodiments, the server comprises a general-purpose computing device, a personal computer, a laptop computer, a mainframe computer, a supercomputer, or any other suitable processing apparatus.

Cloud 120 is a computer network configured to provide on-demand availability of computer system resources, such as data storage and computing power. In some examples, cloud 120 provides resources without active management by a user. The term “cloud” is sometimes used to describe data centers available to many users over the Internet. Some large cloud networks have functions distributed over multiple locations from central servers. A server is designated an edge server if it has a direct or close connection to a user. In some cases, cloud 120 is limited to a single organization. In other examples, cloud 120 is available to many organizations. In one example, cloud 120 includes a multi-layer communications network comprising multiple edge routers and core routers. In another example, cloud 120 is based on a local collection of switches in a single physical location. According to some aspects, cloud 120 provides communications between user device 110, language processing apparatus 115, and database 125.

Database 125 is an organized collection of data. In an example, database 125 stores data in a specified format known as a schema. According to some aspects, database 125 is structured as a single database, a distributed database, multiple distributed databases, or an emergency backup database. In some cases, a database controller manages data storage and processing in database 125. In some cases, a user interacts with the database controller. In other cases, the database controller operates automatically without interaction from the user. According to some aspects, database 125 is external to language processing apparatus 115 and communicates with language processing apparatus 115 via cloud 120. According to some aspects, database 125 is included in language processing apparatus 115.

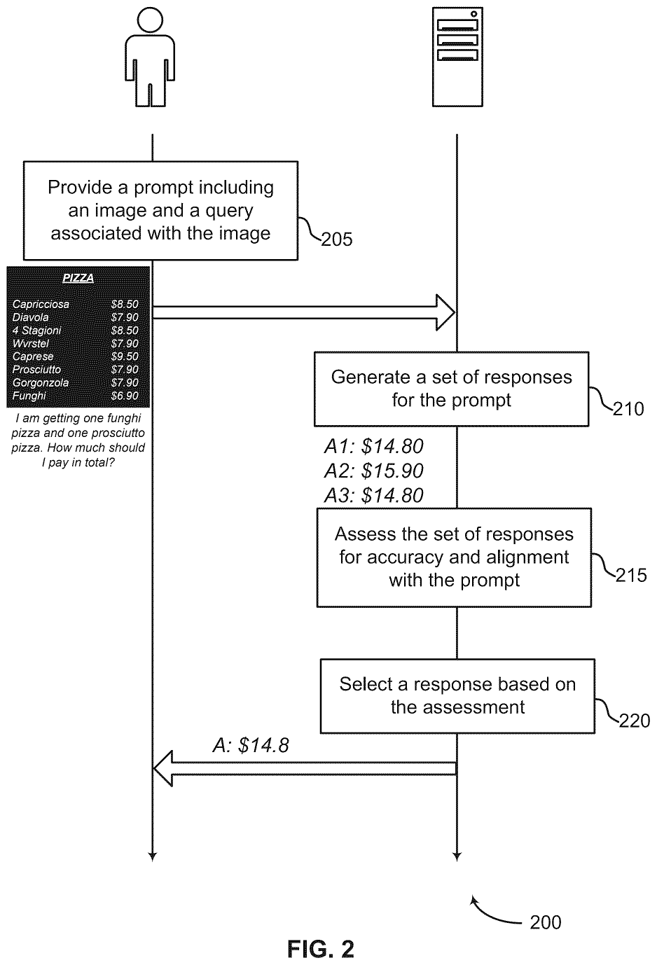

FIG. 2 shows an example of a method 200 for response generation according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps or are performed in conjunction with other operations.

According to an embodiment of the present disclosure, a language processing apparatus (such as the language processing apparatus described with reference to FIGS. 1, 3-4, and 12) provides a panel-of-peers model (such as the panel of per models described with reference to FIGS. 5-9) that accurately generate a response to answer the input query.

At operation 205, the system provides a prompt including an image and a query associated with the image. In some cases, the operations of this step refer to, or may be performed by, a user as described with reference to FIG. 1.

In some cases, the query is a text query that is associated with the image, based on which the user wants to generate a response. For example, the user provides a text prompt instructing the language processing apparatus to generate a response that accurately aligns with the prompt. As shown in FIG. 2, the user provides a prompt comprising an image (such as a food menu) and an associated query such as “I am getting one Funghi pizza and one prosciutto pizza. How much should I pay in total?” to the language processing apparatus via a user interface of a user device (such as a user interface of user device 110 described with reference to FIG. 1).

At operation 210, the system generates a set of responses for the prompt. In some cases, the operations of this step refer to, or may be performed by, a language processing apparatus as described with reference to FIGS. 1 and 3.

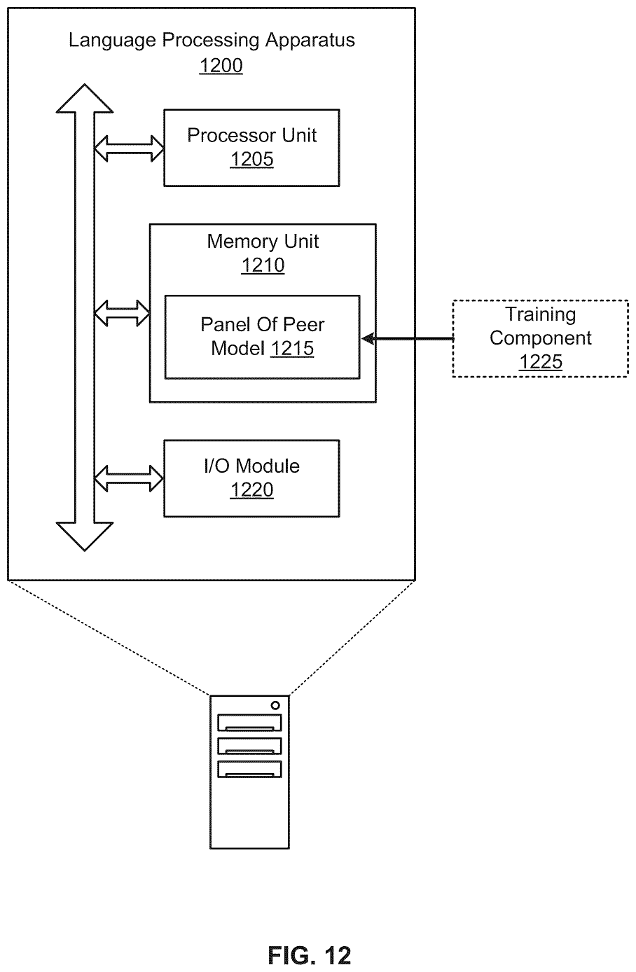

In some cases, the language processing apparatus comprises a panel-of-peers model (such as the panel-of-peers model 1215 described with reference to FIG. 12). In some cases, the panel-of-peers model comprise a plurality of machine learning models. For example, the machine learning model is a language generation model, such as a large vision-language model (LVLM). In some examples, each language generation model of the panel-of-peers model generates a candidate response for an input prompt.

In some cases, the panel-of-peers model comprise a first language generation model, a second language generation model, and a third language generation model. However, embodiments are not limited thereto, and the panel-of-peers model can include any predefined number of language generation models. As shown in FIG. 2, for example, the first language generation model generates a first candidate response (e.g., A1: $14.80) for the input prompt. For example, the second language generation model generates a second candidate response (e.g., A2: $15.90) for the input prompt. For example, the third language generation model generates a third candidate response (e.g., A3: $14.80) for the input prompt.

At operation 215, the system assesses the set of responses for accuracy and alignment with the prompt. In some cases, the operations of this step refer to, or may be performed by, a language processing apparatus as described with reference to FIG. 12.

In some cases, the language processing apparatus performs self-improvement based on an interaction between the plurality of language generation models in the panel-of-peers model. In some cases, each language generation model of the plurality of language generation models in the panel-of-peers model evaluates the candidate responses (such as candidate responses generated in operation 210). In some cases, language processing apparatus evaluates the candidate responses based on a plurality of metrics to generate a reward score.

At operation 220, the system selects a response based on the assessment. In some cases, the operations of this step refer to, or may be performed by, a language processing apparatus as described with reference to FIG. 12.

In some cases, the language processing apparatus generates a preference response dataset using the reward score. For example, the language processing apparatus selects the preference response data as an answer to the query. The selected response is provided to the user via a user interface of the user device (such as user device 110 as described in FIG. 1). Further details regarding the generation of the response and training of the panel-of-peers model are provided with reference to at least FIGS. 5-10.

FIG. 3 shows an example of a response generation process for a vision centric task 300 according to aspects of the present disclosure. Response generation process 300 is an example of, or includes aspects of, the corresponding element described with reference to FIG. 4. In one aspect, response generation process 300 includes input image 305, query 310, language processing apparatus 315, and response 320.

According to an embodiment, user (such as user 105 described with reference to FIG. 1) provides an input prompt (such as input prompt described with reference to FIGS. 1-2). In some cases, input prompt comprises input image 305 and query 310. For example, input image 305 is used for vision centric answering. In some examples, query 310 is a natural language question associated with the input image 305.

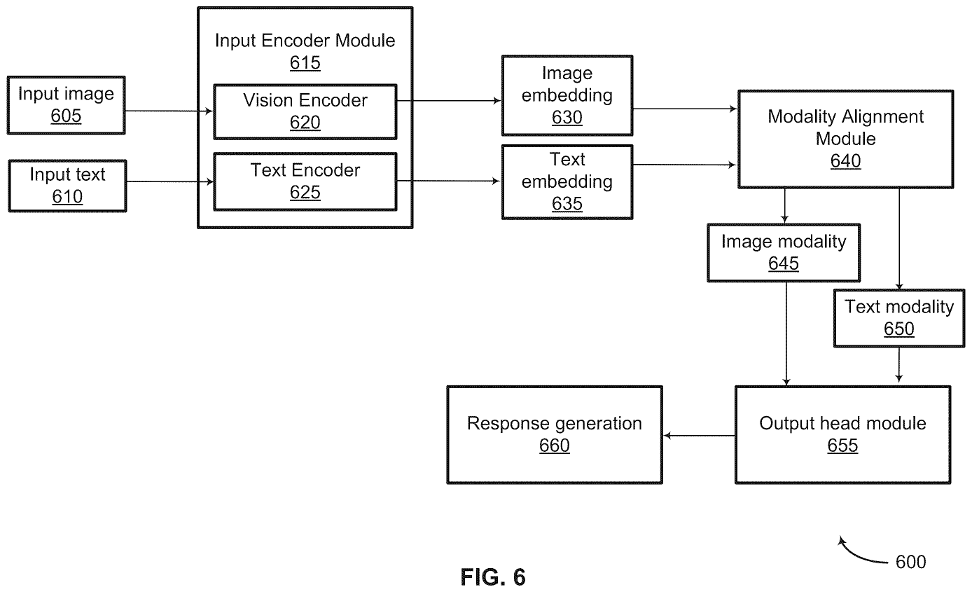

In some cases, user provides input prompt comprising input image 305 and query 310 to language processing apparatus 315 via a user interface of the language processing apparatus 315. For example, as shown in FIG. 3, user provides input image 305 (depicting cars of which one car is red in color; [not shown here due to grayscale image]) and query 310 (such as “Which spot is the red car parked on?”) that is associated with the input image 305 to language processing apparatus 315. Input image 305 is an example of, or includes aspects of, the corresponding element described with reference to FIGS. 4 and 6. Query 310 is an example of, or includes aspects of, the corresponding element described with reference to FIGS. 4, 5, and 9.

The language processing apparatus 315 (such as the language processing apparatus described with reference to at least FIGS. 1-2 and 11) of the present disclosure receives the input prompt comprising input image 305 and query 310 from the user. In some cases, the language processing apparatus 315 comprises a panel-of-peers model including a plurality of language generation models (such as the language generation model described with reference to at least FIGS. 5-6 and 9).

According to an embodiment, each of the language generation models in the language processing apparatus 315 generates a candidate response (candidate response generation as described with reference to FIGS. 2, 5, and 9). Language processing apparatus 315 trains each language generation model using responses generated by each of the other language generation models in the panel-of-peers model to reach a consensus. In some examples, a first language generation model in the panel-of-peers model generates a first candidate response as “the number 73 on the parking lot”. Additionally, in some examples, a second language generation model in the panel-of-peers model generates a second candidate response as “The red car is parked in spot number 37”. In some examples, a third language generation model in the panel-of-peers model generates a third candidate response as “31”.

For example, the language generation model is based on a large vision language model (such as described with reference to FIGS. 5-7). In some cases, the language processing apparatus 315 performs modality alignment in the language generation model (e.g., each of the language generation model in the panel-of-peers model) based on peer-to-peer learning. In some cases, the language processing apparatus 315 fine-tunes each language generation model in the panel-of-peers model to generate response 320. Further details regarding response generation are provided with reference to FIGS. 5-9. Language processing apparatus 315 is an example of, or includes aspects of, the corresponding element described with reference to FIGS. 1 and 4. Response 320 is an example of, or includes aspects of, the corresponding element described with reference to FIG. 4.

FIG. 4 shows an example of a response generation process for general VQA 400 according to aspects of the present disclosure. Response generation process 400 is an example of, or includes aspects of, the corresponding element described with reference to FIG. 3. In one aspect, response generation process 400 includes input image 405, query 410, language processing apparatus 415, and response 420.

According to an embodiment, user (such as user 105 described with reference to FIG. 1) provides an input prompt (such as input prompt described with reference to FIGS. 1-3). In some cases, input prompt comprises input image 405 and query 410. For example, input image 405 is used for visual question answering. In some examples, query 410 is a natural language question associated with the input image 405.

In some cases, user provides input prompt comprising input image 405 and query 410 to language processing apparatus 415 via a user interface of the language processing apparatus 415. For example, as shown in FIG. 4, user provides input image 405 (depicting a food menu) and query 410 (such as “I am getting one Funghi pizza and one prosciutto pizza. How much should I pay in total?”) that is associated with the input image 405 to language processing apparatus 415. Input image 405 is an example of, or includes aspects of, the corresponding element described with reference to FIGS. 3 and 6. Query 410 is an example of, or includes aspects of, the corresponding element described with reference to FIGS. 3, 5, and 9.

The language processing apparatus 415 (such as the language processing apparatus described with reference to at least FIGS. 1-3 and 11) of the present disclosure receives the input prompt comprising input image 305 and query 310 from the user. In some cases, the language processing apparatus 315 comprises a panel-of-peers model including a plurality of language generation models (such as the language generation model described with reference to FIGS. 5-6 and 9).

According to an embodiment, each of the language generation models in the language processing apparatus 415 generates a candidate response (candidate response generation as described with reference to operation 210 in FIG. 2). In some cases, language processing apparatus 415 computes a reward score associated with the plurality of candidate responses based on a metric (including, but not limited to, helpfulness, correctness, verbosity, coherence, and complexity as described with reference to FIG. 8).

An embodiment of the present disclosure is configured to iteratively generate a reward score and fine-tune each language generation model of the panel-of-peers model based on the generated reward score. In some cases, the language processing apparatus is configured to generate a reward score. In some cases, the reward score is generated by combining the evaluations from each language generation model on the panel-of-peers model. Subsequently, language processing apparatus 415 uses evaluations with rejection sampling to generate a preference dataset. In some cases, the preference dataset is used to fine-tune each language generation model of the panel-of-peers model. For example, the language processing apparatus 415 uses the preference dataset to fine-tune each language generation model of the panel-of-peers model using a preference alignment algorithm. Next, language processing apparatus 415 performs supervised fine-tuning of each language generation model based on the preference dataset.

By fine-tuning each language generation model of the panel-of-peers model, language processing apparatus 415 of the present disclosure is able to augment performance of each language generation model, wherein the fine-tuned language generation model generates response 420. Further details regarding response generation are provided with reference to FIGS. 5-9. Language processing apparatus 415 is an example of, or includes aspects of, the corresponding element described with reference to FIGS. 1 and 3. Response 420 is an example of, or includes aspects of, the corresponding element described with reference to FIG. 3.

The present disclosure describes systems and methods for modality alignment. Embodiments of the present disclosure comprise a language processing apparatus that is configured to perform modality alignment in a large vision and language model based on peer-to-peer learning. In some cases, the peer-to-peer learning is based on a panel-of-peers model that induce a learning distribution using an assumption resulting in generation of a response with enhanced quality.

FIG. 5 shows an example of a response generation framework 500 according to aspects of the present disclosure. In one aspect, response generation framework 500 includes panel-of-peers model 505, input prompt 525, response data 540, evaluation data 545, and text 550.

According to an embodiment of the present disclosure, the language processing apparatus is configured to enhance a modality alignment in language generation models (such as first language generation model 510, second language generation model 515, and third language generation model 520). In some cases, the language processing apparatus is configured to construct a panel-of-peers model 505. For example, each language generation model of the panel-of-peers model (e.g., each peer model) depicts similar capacity and performance.

In one aspect, panel-of-peers model 505 includes first language generation model 510, second language generation model 515, and third language generation model 520. However, embodiments are not limited thereto, and the panel-of-peers model can include a different number of machine learning models. Panel-of-peers model 505 are an example of, or includes aspects of, the corresponding element described with reference to FIGS. 9 and 12. First language generation model 510 is an example of, or includes aspects of, the corresponding element described with reference to FIG. 9. Second language generation model 515 is an example of, or includes aspects of, the corresponding element described with reference to FIG. 9. Third language generation model 520 is an example of, or includes aspects of, the corresponding element described with reference to FIG. 9.

In one aspect, as shown in FIG. 5, input prompt 525 includes query 530 and image 535. In some cases, query 530 is associated with image 535. In some cases, the language processing apparatus performs model alignment by generating a candidate response 540 followed by preference data creation (i.e., generation of evaluation data 545) and fine-tuning of the panel-of-peers model 505. In case of the generation of the candidate response 540, the language processing apparatus prompts the panel-of-peers model 505 with the image 535 and query 530 from a selected dataset designed for the models to learn a task (such as including, but not limited to, captioning, OCR, general knowledge, etc.).

For instance, first language generation model 510 generates response data 540 (i.e., a first candidate response) as “[ . . . ] the total cost would be $15.80” based on query 530 and image 535. Similarly, for instance, second language generation model 515 generates response data 540 (i.e., a second candidate response) as “[ . . . ] So, the total cost for one Funghi pizza and one Prosciutto pizza should be $14.80” based on query 530 and image 535. Additionally, for instance, third language generation model 520 generates response data 540 (i.e., a third candidate response) as “[ . . . ] the total cost is 15.90” based on query 530 and image 535.

Input prompt 525 is an example of, or includes aspects of, the corresponding element described with reference to FIG. 9. Query 530 is an example of, or includes aspects of, the corresponding element described with reference to FIGS. 3, 4, and 9. Image 535 is an example of, or includes aspects of, the corresponding element described with reference to FIGS. 3, 4, and 9. Response data 540 is an example of, or includes aspects of, the corresponding element described with reference to FIG. 9.

According to an embodiment of the present disclosure, the language processing apparatus performs a peer-to-peer evaluation on the answers of the models on the panel-of-peers model. In some cases, the language processing apparatus performs an evaluation of response data 540 based on a reward score to generate evaluation data 545. Text 550 is selected based on fine-tuning panel-of-peers model 505 using evaluation data 545. Evaluation data 545 is an example of, or includes aspects of, the corresponding element described with reference to FIG. 9.

Embodiments of the present disclosure are configured to iteratively generate a reward score and fine-tune each language generation model of the panel-of-peers model based on the generated reward score. In some cases, the reward score is generated by combining each evaluation of the language generation models on the panel-of-peers model. Subsequently, the evaluation is used with rejection sampling to generate a preference dataset (such as evaluation data 545).

In some cases, the preference dataset is used to fine-tune each language generation model (e.g., first language generation model 510, second language generation model 515, and third language generation model 520) of the panel-of-peers model 505. For example, the language processing apparatus uses the preference dataset to fine-tune each language generation model of the panel-of-peers model using a preference alignment algorithm. Subsequently, the language processing apparatus performs supervised fine-tuning of each of the language generation models based on the synthetic data. Further details regarding the fine-tuning process are provided with reference to FIG. 9-10.

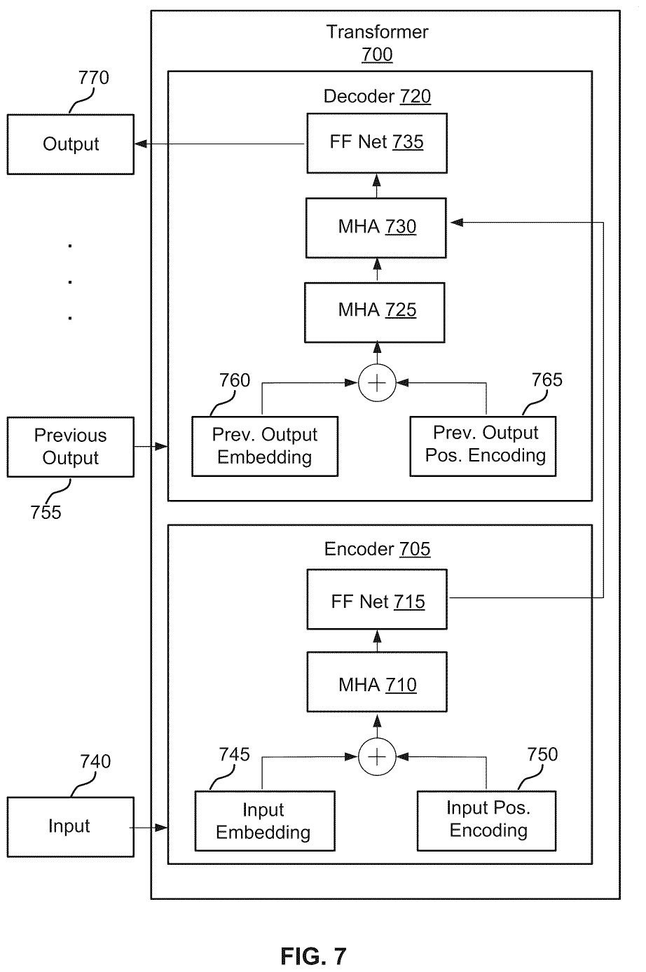

Large vision-language models (LVLMs) enable systems to integrate and process visual and textual data for various tasks such as image captioning, visual question answering, and multimodal reasoning. The LVLM leverages a deep learning architecture (such as a network described with reference to FIG. 6), including transformers (such as a transformer network described with reference to FIG. 7) and vision encoders, to align features from visual and linguistic modalities effectively.

For instance, an LVLM answers a user query by analyzing an input image (e.g., an image of a product) and providing relevant text-based information (e.g., product specifications or usage instructions, etc.). In some examples, when a user queries an LVLM with an image and a text prompt, the model extracts and aligns meaningful features to generate a coherent response. In some cases, embodiments of the present disclosure are used to fine-tune LVLMs to enhance cross-modal reasoning performance, interpretability, and resource efficiency while reducing computational overhead.

FIG. 6 shows an example of a large vision-language model 600 according to aspects of the present disclosure. In one aspect, large vision-language model 600 includes input encoder module 615, modality alignment module 640, and output head module 655.

In one aspect, as shown in FIG. 6, input encoder module 615 includes vision encoder 620 and text encoder 625. In some cases, vision encoder 620 processes input image 605 (e.g., input image or an input video) to generate a set of feature embeddings, such as image embedding 630. For instance, vision encoder 620 divides input image 605 into small regions or patches, where each region is represented as a vector in a high-dimensional space. Input image 605 is an example of, or includes aspects of, the corresponding element described with reference to FIGS. 3 and 4.

Additionally, text encoder 625 processes input text 610 (e.g., input question, an input caption, or an input description) to generate a sequence of embeddings, such as text embedding 635. For instance, text encoder 625 tokenizes input text 610, i.e., splits the text into words and subwords. The tokens are passed through multiple layers of transformers (such as a transformer network described with reference to FIG. 7) to extract linguistic features.

According to an embodiment, modality alignment module 640 aligns image embedding 630 and text embedding 635 in a shared space for cross-modal understanding. In some examples, an attention mechanism associates a word (such as “dog”) with the corresponding part of the image that contains the dog. In some cases, the modality alignment module 640 learns a relationship between visual features and textual features via training on paired data (e.g., image-text pairs). For example, the modality alignment module 640 learns how visual features map to textual descriptions resulting in generation of image modality 645 and text modality 650.

As used herein, “attention” refers to a mechanism that provides for a language generation model to focus on different parts of a sequence of tokens when making predictions. The language generation model uses attention to weigh an importance of different tokens regardless of their position in the sequence.

In some cases, large vision-language model 600 performs reasoning to understand the combined input using the aligned features. By understanding the combined input, large vision-language model 600 is able to accurately perform response generation 660 based on output head module 655. For example, in case a text is “What is the dog doing?”, large vision-language model 600 identifies actions related to the dog in the image (e.g., running, sitting). Accordingly, large vision-language model 600 generates a specific answer such as “running” for visual question answering. Additionally, large vision-language model 600 generates description such as “A dog running in a grassy park” for an input image.

FIG. 7 shows example of a transformer network 700 according to aspects of the present disclosure. The example shown includes transformer 700, encoder 705, decoder 720, input 740, input embedding 745, input positional encoding 750, previous output 755, previous output embedding 760, previous output positional encoding 765, and output 770. According to some aspects, encoder 705 is implemented as a video encoder of a multi-modal encoder. According to some aspects, encoder 705 is implemented as a text encoder of conditional text encoder. According to some aspects, transformer 700 is implemented in the panel-of-peers model (such as the panel-of-peers model described with reference to FIGS. 5-9).

In some cases, encoder 705 includes multi-head self-attention sublayer 710 and feed-forward network sublayer 715. In some cases, decoder 720 includes first multi-head self-attention sublayer 725, second multi-head self-attention sublayer 730, and feed-forward network sublayer 735.

In some cases, encoder 705 is configured to map input 740 (for example, a text prompt) to a sequence of continuous representations that are fed into decoder 720. In some cases, decoder 720 generates output 770 (e.g., a prediction of an output sequence of words or tokens) based on the output of encoder 705 and previous output 755 (e.g., a previously predicted output sequence), which allows for the use of autoregression.

For example, in some cases, encoder 705 parses input 740 into tokens and vectorizes the parsed tokens to obtain input embedding 745, and adds input positional encoding 750 (e.g., positional encoding vectors for input 740 of a same dimension as input embedding 745) to input embedding 745. In some cases, input positional encoding 750 includes information about relative positions of words or tokens in input 740.

In some cases, encoder 705 comprises one or more encoding layers that generate contextualized token representations, where each representation corresponds to a token that combines information from other input tokens via self-attention mechanism. In some cases, each encoding layer of encoder 705 comprises a multi-head self-attention sublayer (e.g., multi-head self-attention sublayer 710). In some cases, the multi-head self-attention sublayer implements a multi-head self-attention mechanism that receives different linearly projected versions of queries, keys, and values to produce outputs in parallel. In some cases, each encoding layer of encoder 705 also includes a fully connected feed-forward network sublayer (e.g., feed-forward network sublayer 715) comprising two linear transformations surrounding a Rectified Linear Unit (ReLU) activation:

$$FFN ( x ) = ReLU ( {W}_{1} x + {b}_{1} ) {W}_{2} + {b}_{2} \qquad ( 1 )$$

In some cases, each layer employs different weight parameters (W₁, W₂) and different bias parameters (b₁, b₂) to apply a same linear transformation each word or token in input 740.

In some cases, each sublayer of encoder 705 is followed by a normalization layer that normalizes a sum computed between a sublayer input x and an output sublayer (x) generated by the sublayer:

$$layernorm ( x + sublayer ( x ) ) \qquad ( 2 )$$

In some cases, encoder 705 is bidirectional because encoder 705 attends to each word or token in input 740 regardless of a position of the word or token in input 740.

According to some aspects, encoder 705 functions as a text encoder of the conditional text encoder. In an example, conditional text encoder splits an input text into fixed-size segments, generates a linear embedding of each of the segments, adds position embeddings to each of the linear embeddings, and provides the resulting sequence of vectors as input 740 to encoder 705.

In some cases, decoder 720 comprises one or more decoding layers (e.g., six decoding layers). In some cases, each decoding layer comprises three sublayers including a first multi-head self-attention sublayer (e.g., first multi-head self-attention sublayer 725), a second multi-head self-attention sublayer (e.g., second multi-head self-attention sublayer 730), and a feed-forward network sublayer (e.g., feed-forward network sublayer 735). In some cases, each sublayer of decoder 720 is followed by a normalization layer that normalizes a sum computed between a sublayer input x and an output sublayer (x) generated by the sublayer.

In some cases, decoder 720 generates previous output embedding 760 of previous output 755 and adds previous output positional encoding 765 (e.g., position information for words or tokens in previous output 755) to previous output embedding 760. In some cases, each first multi-head self-attention sublayer receives the combination of previous output embedding 760 and previous output positional encoding 765 and applies a multi-head self-attention mechanism to the combination. In some cases, for each word in an input sequence, each first multi-head self-attention sublayer of decoder 720 attends only to words preceding the word in the sequence, and so a prediction of transformer 700 for a word at a particular position only depends on known outputs for a word that came before the word in the sequence.

For example, in some cases, each first multi-head self-attention sublayer implements multiple single-attention functions in parallel by introducing a mask over values produced by the scaled multiplication of matrices Q and K by suppressing matrix values that would otherwise correspond to disallowed connections.

In some cases, each second multi-head self-attention sublayer implements a multi-head self-attention mechanism similar to the multi-head self-attention mechanism implemented in each multi-head self-attention sublayer of encoder 705 by receiving a query Q from a previous sublayer of decoder 720 and a key K and a value V from the output of encoder 705, allowing decoder 720 to attend to each word in the input 740.

In some cases, each feed-forward network sublayer implements a fully connected feed-forward network similar to feed-forward network sublayer 715. In some cases, the feed-forward network sublayers are followed by a linear transformation and a softmax to generate a prediction of output 770.

As described herein, a transformer or transformer network (such as transformer network 700) is a type of neural network model used for natural language processing tasks. A transformer network transforms one sequence into another sequence using an encoder and a decoder. Encoder and decoder include modules that can be stacked on top of each other multiple times. The modules comprise multi-head attention and feed forward layers. The inputs and outputs (target sentences) are first embedded into an n-dimensional space. Positional encoding of the different words (i.e., give every word/part in a sequence a relative position since the sequence depends on the order of its elements) are added to the embedded representation (n-dimensional vector) of each word.

In some examples, a transformer network includes attention mechanism, where the attention looks at an input sequence and decides at each step which other parts of the sequence are important. The attention mechanism involves query, keys, and values denoted by Q, K, and V, respectively. Q is a matrix that contains the query (vector representation of one word in the sequence), K are all the keys (vector representations of all the words in the sequence) and V are the values, which are again the vector representations of all the words in the sequence. For the encoder and decoder, multi-head attention modules, V consists of the same word sequence than Q. However, for the attention module that is taking into account the encoder and the decoder sequences, V is different from the sequence represented by Q. In some cases, values in V are multiplied and summed with some attention-weights a.

In language models, the transformer architecture enables processing of variable-length text sequences through self-attention mechanisms. The model processes input text by converting words or subwords into embeddings and applying multiple layers of self-attention and feed-forward neural networks. Each layer allows the model to learn increasingly complex relationships between words in the input sequence. The self-attention mechanism enables the model to weigh the importance of different words in the context when predicting the next word or performing other language tasks. This architecture can be scaled to handle large amounts of text data by increasing the number of parameters, layers, and attention heads, leading to improved performance on various natural language processing tasks such as text generation, translation, and comprehension.

Multimodal large language models (MLLMs) extend the transformer architecture to process both text and other modalities such as images or audio. One implementation approach involves using separate encoders for different modalities, such as a vision encoder for processing images and a language model for processing text. The vision encoder converts visual information into a dense vector representation in the same dimensional space as the text embeddings. A modality interface or connector then aligns these representations with the language model's embedding space, allowing the model to process both modalities coherently.

The language model can then generate text outputs based on both the visual and textual inputs it receives. This architecture enables the model to perform tasks that require understanding and generating text based on multiple types of input, such as answering questions about images or generating descriptions of visual content.

Accordingly, an apparatus for language processing apparatus is described. One or more aspects of the apparatus include a memory component; a processing device coupled to the memory component, the processing device configured to perform operations comprising: obtaining a dataset including an input prompt; generating, using a panel-of-peers model, response data based on the input prompt, wherein the response data includes a first response generated by a first language generation model of the panel-of-peers model and a second response generated by a second language generation model of the panel-of-peers model that is different from the first language generation model; generating, using the panel-of-peers model, evaluation data based on the response data, wherein the evaluation data includes a first evaluation of the first response and a second evaluation of the second response, wherein the first evaluation is generated by the second language generation model and the second evaluation is generated by the first language generation model; and training the panel-of-peers model based on the evaluation data.

In some aspects, the panel-of-peers model comprises a plurality of large vision-language models. In some aspects, each of the panel-of-peers model is pre-trained using a same training set. In some aspects, each of the panel-of-peers model comprises a different network architecture. In some aspects, each of the panel-of-peers model is iteratively updated based on the evaluation data.

### Response Generation Process

Embodiments of the present disclosure are configured to perform a panel-of-peer models learning for enhancing self-improvement in a language generation model. For example, the language generation model is a large vision-language model (LVLM). In some cases, the self-improvement of the language generation model is enhanced by generating synthetic preference data. According to an embodiment, the panel-of-peer models learning is used as an ensemble method during inference.

The present disclosure describes systems and methods for language processing, more specifically to response generation. Embodiments of the present disclosure include a language processing apparatus comprising a plurality of language generation models as a panel-of-peers model. In some cases, each of the plurality of language generation models is configured to generate synthetic data for performing the autonomous self-improvement. For example, the language processing apparatus is configured to fine-tune each of the plurality of language generation models using the synthetic data based on an iterative interaction among the language generation models of the panel-of-peers model.

FIG. 8 shows an example of a method 800 for language processing apparatus according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps or are performed in conjunction with other operations.

At operation 805, the system obtains a dataset including an input prompt. In some cases, the operations of this step refer to, or may be performed by, a language processing apparatus as described with reference to FIG. 12.

For example, in some cases, the user interface of the language processing apparatus (such as language processing apparatus 1200 described with reference to FIG. 12) receives an input prompt from a user. In some examples, the input prompt comprises an image and a text query associated with the image that the user wants a response to. In some examples, the language processing apparatus receives the input prompt comprising the image and an associated text query from a database or any other data source.

At operation 810, the system generates, using a panel-of-peers model, response data based on the input prompt, where the response data includes a first response generated by a first language generation model of the panel-of-peers model and a second response generated by a second language generation model of the panel-of-peers model that is different from the first language generation model. In some cases, the operations of this step refer to, or may be performed by, a panel-of-peers model as described with reference to FIGS. 5, 9, and 12.

In some cases, an autoregressive language generation model (such as the first language generation model and the second language generation model described with reference to FIG. 5) comprises an image token projected into an embedding space of textual information. Subsequently, the projected image token is concatenated. In some cases, the language processing apparatus of the present disclosure uses a panel-of-peers model (such as the panel-of-peers model described with reference to FIGS. 5 and 9) comprising pre-trained language generation models. For example, the language generation models are pretrained followed by an alignment process and a supervised fine-tuning (SFT) process.

In some cases, each language generation model of the panel-of-peers model has similar performance. In some cases, each language generation model is used to perform self-improvement for enhancing capabilities and performance of the language generation model. In some cases, the language processing apparatus implements a self-bootstrapping loop, where each language generation model performs the self-improvement. Subsequently, the language processing apparatus augments the panel-of-peers model with best-of-N sampling by providing for each language generation model of the panel-of-peers model to generate a candidate response (such as candidate response described with reference to FIGS. 5 and 9).

For instance, each language generation model of the panel-of-peers model receives an input image and a query pair (e.g., each language generation model receives the same input image and input query). In some examples, the language generation model is configured to generate a candidate response based on the input image and the query pair. In some examples, each language generation model of the panel-of-peers model generates multiple responses corresponding to each query.

At operation 815, the system generates, using the panel-of-peers model, evaluation data based on the response data, where the evaluation data includes a first evaluation of the first response and a second evaluation of the second response, where the first evaluation is generated by the second language generation model and the second evaluation is generated by the first language generation model. In some cases, the operations of this step refer to, or may be performed by, a panel-of-peers model as described with reference to FIGS. 5, 9, and 12.

An embodiment of the present disclosure is configured to perform a peer-to-peer evaluation, wherein the panel-of-peers model comprise a plurality of language generation models (such as LVL M s described in at least FIG. 6). In some cases, each language generation model scores the candidate response generated by each of the other language generation models of the panel-of-peers model.

For instance, in case language generation model πᵢ evaluates the candidate response of the other language generation models in the panel-of-peers model, the model πᵢ scores candidate response yⱼ as πⱼ(yⱼ|x), where x is a query such as “Where is the car parked?”. In some examples, the candidate response y; generated by language generation model πᵢ is “The car is parked in spot 31”. Additionally, the language generation model Tri generates a plurality of candidate responses corresponding to the query (in multiple tries).

According to an embodiment, the language processing apparatus generates a prompt that evaluates each candidate response based on a plurality of characteristics. For instance, the language processing apparatus generates prompt p that evaluates each candidate response of the language generation model based on characteristics, such as, but not limited to, helpfulness, correctness, verbosity, coherence, and complexity, to generate a pseudo-reward for learning. In some examples, the language processing apparatus grades the pseudo-reward score (e.g., on a Likert scale) from 1 to 5 followed by performing a summation. Subsequently, for example, the language processing apparatus divides the summation by 25 to normalize the score to the 0-1 range. The reward score is generated using the normalized value.

In some examples, the language processing apparatus performs a single-point scoring. For example, the language processing apparatus rates the quality of each candidate response associated with each language generation model independently in case of single-point scoring. In some examples, the language processing apparatus performs a relative-point scoring. For example, the language processing apparatus rates the quality of each candidate response associated with each language generation model in comparison with the candidate response of another language generation model in case of relative-point scoring.

According to an embodiment, the language generation model Ti evaluates the candidate response of the other language generation models in the panel-of-peers model. In some cases, the language generation model πᵢ receives a natural language instruction on performing the grading that generates the pseudo-reward score. In some cases, the reward score is based on an internal knowledge of the evaluating model (e.g., πᵢ).

An embodiment of the present disclosure is configured to generate a panel of M peer models. For instance, as shown in FIGS. 5 and 9, M=3. However, embodiments are not limited thereto and the number of language generation models in the panel-of-peers model can vary. In some cases, each language generation model independently assigns a reward score between 0 and 1 to a given peer output. As a result, the language processing apparatus generates reward score Rᵢ(yⱼ)=πᵢ(·|p∪x∪yⱼ), where y is the model output, x is the original question, and p is the evaluation prompt.

An embodiment of the present disclosure is configured to generate a combined reward score based on combining the reward score generated by each language generation model. In some cases, the language processing apparatus combines individual reward scores (from each candidate response corresponding to the multiple tries) from the panel-of-peers model and generates a combined reward score. In some cases, the combined reward score is based on at least one of a mean voting method, a minimum voting method, and/or an uncertainty-weighted voting method.

For example, the mean voting R_{μ}(yⱼ) performs an average of the outputs from each language generation model of the panel-of-peers model. For example, the minimum voting R_{MIN}(yⱼ) obtains the minimum score across the panel which results in prevention of overoptimistic reward estimates. For example, the uncertainty-weighted voting adjusts the average reward by penalizing high intra-ensemble variance using a coefficient λ.

$${R}_{UW} ( {y}_{j} ) = {R}_{μ} ( {y}_{j} ) = λ \frac{1}{M} {\sum }_{i = 1}^{M} {( {R}_{i} ( y ) - {R}_{μ} ( y ) )}^{2} \qquad ( 3 )$$

In some cases, the language processing apparatus computes a reward score R(y) corresponding to each response y. For instance, the reward score is generated based on at least one of the mean voting method, the minimum voting method, and/or the uncertainty-weighted voting method. In some examples, the language processing apparatus applies rejection sampling, wherein the preference dataset (i.e., evaluation data described with reference to FIGS. 5 and 9) is generated based on selecting samples with a predetermined reward score (such as a reward score of at least 0.85).

In some cases, the language processing apparatus augments the generated candidate responses (candidate responses generated in operation 810 and further described in FIGS. 5 and 9) using Best-of-N sampling. For example, the Best-of-N sampling refers to an inference based alignment algorithm. In some examples,

$${Y}_{N} = {\{ {y}^{( n )} \}}_{n = 1}^{N}$$

is multi-set comprising N i.i.d. samples from πᵢ(yᵢ|x) for a query x. The Best-of-N algorithm returns y*, where:

$${y}^{*} = {arg max}_{{y}^{( n )} ∈ {Y}_{N}} r ( {y}^{( n )} ) \qquad ( 4 )$$

In some cases, the Best-of-N algorithm is win-rate optimal and KL optimal asymptotically to the preference alignment data generation. In some cases, the language processing apparatus generates N×M candidate responses after sampling N answers using sentence-level beam search from each of the M models of the panel-of-peers model.

At operation 820, the system trains the panel-of-peers model based on the evaluation data. In some cases, the operations of this step refer to, or may be performed by, a training component as described with reference to FIGS. 9-10.

An embodiment of the present disclosure is configured to generate a training dataset based on the candidate response corresponding to the reward score. In some cases, the language processing apparatus selects the response with the maximum reward as the preferred response (i.e., evaluation data generated at operation 815) for each input prompt. In some cases, the evaluation data is used to generate a supervised fine-tuning (SFT) dataset for finetuning the language generation model of the panel-of-peers model. For example, each language generation model of the panel-of-peers model is trained iteratively based on the SFT dataset.

In some cases, for each iteration t, the language processing apparatus generates the constructed data as

$${𝒟}_{t} = {\{ ( I , x , {y}^{( n )} ) \}}_{i = {1}^{′}}^{\vert 𝒟 \vert}$$

where I represents the image, x is the text prompt, and y (n) is the highest ranked answer by the panel-of-peers model after filtering. In some cases, the language processing apparatus fine-tunes each language generation model of the panel-of-peers model independently after obtaining the training data. For example, the language generation model is fine-tuned to maximize a log-likelihood of the distribution induced by the panel-of-peers model. The objective function to perform the fine-tuning is given as:

$${ℒ}_{SFT - POP} ( {π}_{{θ}_{t + 1}} , {π}_{{θ}_{t}} ) = - {𝔼}_{{𝒟}_{t}} [ log {π}_{{θ}_{t}} ( {y}^{( n )} ) ] \qquad ( 5 )$$

where π_{θ}_{ₜ₊₁} and π_{θ}_{ₜ} represent the language generation models from a next iteration and a previous iteration, respectively. In some examples, the optimization of the language generation models is performed for each language generation model of the panel-of-peers model.

In case of a subsequent iteration, the process of candidate response generation followed by data creation and fine-tuning is repeated. For example, in case of an iteration, each language generation model is initialized from a checkpoint of a previous iteration. In some cases, the language generation model optimization is performed based on the SFT dataset, however, embodiments are not limited thereto, and the language generation model can be optimized using any other suitable optimization method.

Accordingly, a method for language processing apparatus is described. One or more aspects of the method include obtaining a dataset including an input prompt; generating, using a panel-of-peers model, response data based on the input prompt, wherein the response data includes a first response generated by a first language generation model of the panel-of-peers model and a second response generated by a second language generation model of the panel-of-peers model that is different from the first language generation model; generating, using the panel-of-peers model, evaluation data based on the response data, wherein the evaluation data includes a first evaluation of the first response and a second evaluation of the second response, wherein the first evaluation is generated by the second language generation model and the second evaluation is generated by the first language generation model; and training the panel-of-peers model based on the evaluation data.

In some aspects, the input prompt comprises an image and a query about the image. In some aspects, the dataset includes a plurality of input prompts corresponding to a plurality of different training tasks. In some aspects, the evaluation data comprises a plurality of evaluation parameters including a helpfulness parameter, a correctness parameter, a verbosity parameter, a coherence parameter, a complexity parameter, or any combination thereof.

Some examples of the method, apparatus, and non-transitory computer readable medium further include computing a first aggregate reward score for the first response and a second aggregate reward score for the second response based on the evaluation data. Some examples of the method, apparatus, and non-transitory computer readable medium further include selecting the first response as a training response based on the evaluation data, wherein the panel-of-peers model is trained based on the first response.

Some examples of the method, apparatus, and non-transitory computer readable medium further include training the panel-of-peers model comprises iteratively training the panel-of-peers model based on a plurality of input prompts in the dataset. Some examples of the method, apparatus, and non-transitory computer readable medium further include generating text using the first language generation model based on the training.

Additionally, a method for language processing apparatus is described. One or more aspects of the method include obtaining a dataset including an input prompt comprising an image and a query about the image; generating, using a panel-of-peers model, response data based on the input prompt, wherein the response data includes a first response to the query generated by a first language generation model of the panel-of-peers model and a second response to the query generated by a second language generation model of the panel-of-peers model; and training the panel-of-peers model to respond to the query about the image based on the response data.

In some aspects, the dataset includes a plurality of input prompts corresponding to a plurality of different training tasks. In some aspects, an evaluation data comprises a plurality of evaluation parameters including a helpfulness parameter, a correctness parameter, a verbosity parameter, a coherence parameter, a complexity parameter, or any combination thereof.

Some examples of the method, apparatus, and non-transitory computer readable medium further include computing a first aggregate reward score for the first response and a second aggregate reward score for the second response based on the evaluation data. Some examples of the method, apparatus, and non-transitory computer readable medium further include selecting the first response as a training response based on the evaluation data, wherein the panel-of-peers model is trained based on the first response.

Some examples of the method, apparatus, and non-transitory computer readable medium further include iteratively training the panel-of-peers model based on a plurality of input prompts in the dataset. Some examples of the method, apparatus, and non-transitory computer readable medium further include generating text using the first language generation model based on the training.

### Training the System

Embodiments of the present disclosure are configured to perform a panel-of-peer models learning for enhancing self-improvement in a language generation model. For example, the language generation model is a large vision-language model (LVLM). In some cases, the self-improvement of the language generation model is enhanced by generating synthetic preference data. According to an embodiment, the panel-of-peer models learning is used as an ensemble method during inference.

By simultaneously using each language generation model of the panel-of-peers model as an evaluator and a response generator for synthetic data generation, embodiments of the present disclosure are able to iteratively refine the knowledge of each language generation model of the panel-of-peers model. Additionally, by implementing the language generation models of the panel-of-peers model with more refined knowledge based on the iterative process, embodiments are able to enhance quality and performance of the models using a single inference step (i.e., instead of a plurality of steps).

In some cases, the iterative process of panel-of-peer models training ensures continuous enhancement in the performance of the language generation model compared to existing response generation systems. In some cases, the iterative process is performed based on a dataset of queries. Accordingly, by implementing the dataset of queries for the iterative enhancement, embodiments of the present disclosure are able to reduce or prevent use of human annotations.

Additionally, the panel-of-peer model learning enables implementation of complementary knowledge from other language generation models in the panel-of-peers model. For example, a language generation model with reduced OCR capability is able to enhance the OCR capability based on cross-model knowledge transfer among the other language generation models in the panel-of-peers model.

In some cases, the panel-of-peer model learning is implemented for models associated with a unimodal input. In some cases, the panel-of-peer model learning is implemented for models associated with a multimodal input. For example, the panel-of-peer model learning is extensible, i.e., a model of any given size or capacity in a panel-of-peers can use panel-of-peer model learning.

FIG. 9 shows an example of a framework for training the panel-of-peers model 900 according to aspects of the present disclosure. In one aspect, training process 900 includes input prompt 905, panel-of-peers model 915, response generation 935, response evaluation 940, and training response 945.

As shown with reference to FIG. 9, the framework for training the panel-of-peers model 900 alternates between generation of response data 935, generation of evaluation data by response evaluation 940, and simultaneous fine-tuning of the panel-of-peers model 915. In case of the generation of response data 935, the language processing apparatus (such as language processing apparatus described with reference to FIGS. 1-3) prompts the panel-of-peers model 915 with an image and an associated question from a dataset of prompts 905.

In some cases, the language processing apparatus prompts the panel-of-peers model 915 to learn a diverse set of tasks including, but not limited to, captioning, OCR, general knowledge, etc. As indicated in FIG. 9, a dataset of prompts comprises input prompt 905 includes image and query 910. Image is an example of, or includes aspects of, the input image described with reference to FIGS. 1-5. Input prompt 905 is an example of, or includes aspects of, the corresponding element described with reference to FIG. 5. Query 910 is an example of, or includes aspects of, the corresponding element described with reference to FIGS. 3-5.

In one aspect, panel-of-peers model 915 include first language generation model 920, second language generation model 925, and third language generation model 930. However, embodiments are not limited thereto, and the panel-of-peers model 915 can include two or more language generation models. As shown in FIG. 9, each of the first language generation model 920, second language generation model 925, and third language generation model 930 receives the same input image and associated query and generates a candidate response, such as response generation 935. In some cases, each of the first language generation model 920, second language generation model 925, and third language generation model 930 generates a plurality of candidate responses (i.e., indicated in response generation 935) in multiple tries.

Subsequently, the language processing apparatus computes a reward score for each candidate response data. Further details regarding computation of the reward score are provided with reference to FIG. 8. The language processing apparatus retains selected samples (i.e., evaluation data) based on response evaluation 940 using the reward score. For instance, the language processing apparatus augments the response data generated during response generation 935 using an alignment algorithm (such as the alignment algorithm described in FIG. 8).

In some cases, each of first language generation model 920, second language generation model 925, and third language generation model 930 of panel-of-peers model 915 performs peer-to-peer evaluation of each of the other language generation models on the panel-of-peers model 915. For example, first language generation model 920 performs peer-to-peer evaluation the second language generation model 925 and the third language generation model 930. Similarly, second language generation model 925 performs peer-to-peer evaluation of the first language generation model 920 and the third language generation model 930.

Panel-of-peers model 915 is an example of, or includes aspects of, the corresponding element described with reference to FIGS. 5 and 12. First language generation model 920 is an example of, or includes aspects of, the corresponding element described with reference to FIG. 5. Second language generation model 925 is an example of, or includes aspects of, the corresponding element described with reference to FIG. 5. Third language generation model 930 is an example of, or includes aspects of, the corresponding element described with reference to FIG. 5. Response generation 935 is an example of, or includes aspects of, the corresponding element described with reference to FIG. 5.

As shown in FIG. 9, the language processing apparatus curates a training response 945 after generating candidate responses with the associated reward score. For each input prompt, the language processing apparatus performs response evaluation 940 and selects the response with the maximum reward score as evaluation data or a preferred response to generate a SFT dataset for fine-tuning (i.e., training response 945). Response evaluation 940 is an example of, or includes aspects of, the corresponding element described with reference to FIG. 5.

According to an embodiment, the panel-of-peers model 915 are trained based on the preferred response or training response 945. In some cases, each of the first language generation model 920, second language generation model 925, and third language generation model 930 of panel-of-peers model 915 are trained iteratively and then finetuned to maximize the log-likelihood of the distribution induced by the panel-of-peers model 915. The optimization is performed for each of the first language generation model 920, second language generation model 925, and third language generation model 930 of panel-of-peers model 915.

In case of a subsequent iteration, the process of candidate response generation and data generation and fine-tuning is repeated, such that the panel-of-peers model 915 are initialized from checkpoints of a previous iteration. According to an embodiment, supervised fine-tuning is used as an optimization method. However, embodiments are not limited thereto, and another suitable optimization method can be used. Further details regarding the process of candidate response generation and data generation and fine-tuning are provided with reference to FIG. 8.

FIG. 10 shows an example of a method of training a machine learning model according to aspects of the present disclosure. FIG. 10 is a flow diagram depicting an algorithm as a step-by-step procedure 1000 in an example implementation of operations performable for training a machine-learning model. In some embodiments, the procedure 1000 describes an operation of the training component 1225 described for configuring the panel-of-peers model 1215 as described with reference to FIG. 12. The procedure 1000 provides one or more examples of generating training data, use of the training data to train a machine-learning model, and use of the trained machine-learning model to perform a task.

To begin in this example, a machine-learning system collects training data (block 1002) that is to be used as a basis to train a machine-learning model, i.e., which defines what is being modeled. The training data is collectable by the machine-learning system from a variety of sources. Examples of training data sources include public datasets, service provider system platforms that expose application programming interfaces (e.g., social media platforms), user data collection systems (e.g., digital surveys and online crowdsourcing systems), and so forth. Training data collection may also include data augmentation and synthetic data generation techniques to expand and diversify available training data, balancing techniques to balance a number of positive and negative examples, and so forth.

The machine-learning system is also configurable to identify features that are relevant (block 1004) to a type of task, for which the machine-learning model is to be trained. Task examples include classification, natural language processing, generative artificial intelligence, recommendation engines, reinforcement learning, clustering, and so forth. To do so, the machine-learning system collects the training data based on the identified features and/or filters the training data based on the identified features after collection. The training data is then utilized to train a machine-learning model.

In order to train the machine-learning model in the illustrated example, the machine-learning model is first initialized (block 1006). Initialization of the machine-learning model includes selecting a model architecture (block 1008) to be trained. Examples of model architectures include neural networks, convolutional neural networks (CNNs), long short-term memory (LSTM) neural networks, generative adversarial networks (GANs), decision trees, support vector machines, linear regression, logistic regression, Bayesian networks, random forest learning, dimensionality reduction algorithms, boosting algorithms, deep learning neural networks, etc.

A loss function is also selected (block 1010). The loss function is utilized to measure a difference between an output of the machine-learning model (i.e., predictions) and target values (e.g., as expressed by the training data) to be used to train the machine-learning model. Additionally, an optimization algorithm is selected (1012) that is to be used in conjunction with the loss function to optimize parameters of the machine-learning model during training, examples of which include gradient descent, stochastic gradient descent (SGD), and so forth.

Initialization of the machine-learning model further includes setting initial values of the machine-learning model (block 1014) examples of which includes initializing weights and biases of nodes to improve efficiency in training and computational resources consumption as part of training. Hyperparameters are also set that are used to control training of the machine learning model, examples of which include regularization parameters, model parameters (e.g., a number of layers in a neural network), learning rate, batch sizes selected from the training data, and so on. The hyperparameters are set using a variety of techniques, including use of a randomization technique, through use of heuristics learned from other training scenarios, and so forth.

The machine-learning model is then trained using the training data (block 1018) by the machine-learning system. A machine-learning model refers to a computer representation that can be tuned (e.g., trained and retrained) based on inputs of the training data to approximate unknown functions. In particular, the term machine-learning model can include a model that utilizes algorithms (e.g., using the model architectures described above) to learn from, and make predictions on, known data by analyzing training data to learn and relearn to generate outputs that reflect patterns and attributes expressed by the training data.

Examples of training types include supervised learning that employs labeled data, unsupervised learning that involves finding an underlying structures or patterns within the training data, reinforcement learning based on optimization functions (e.g., rewards and/or penalties), use of nodes as part of “deep learning,” and so forth. The machine-learning model, for instance, is configurable as including a plurality of nodes that collectively form a plurality of layers. The layers, for instance, are configurable to include an input layer, an output layer, and one or more hidden layers. Calculations are performed by the nodes within the layers through the hidden states through a system of weighted connections that are “learned” during training, e.g., through use of the selected loss function and backpropagation to optimize performance of the machine-learning model to perform an associated task.

As part of training the machine-learning model, a determination is made as to whether a stopping criterion is met (decision block 1020), i.e., which is used to validate the machine-learning model. The stopping criterion is usable to reduce overfitting of the machine-learning model, reduce computational resource consumption, and promote an ability of the machine-learning model to address previously unseen data, i.e., that is not included specifically as an example in the training data. Examples of a stopping criterion include but are not limited to a predefined number of epochs, validation loss stabilization, achievement of a performance improvement threshold, whether a threshold level of accuracy has been met, or based on performance metrics such as precision and recall. If the stopping criterion has not been met (“no” from decision block 1020), the procedure 1000 continues training of the machine-learning model using the training data (block 1018) in this example.

If the stopping criterion is met (“yes” from decision block 1020), the trained machine-learning model is then utilized to generate an output based on subsequent data (block 1022). The trained machine-learning model, for instance, is trained to perform a task as described above and therefore, once trained is configured to perform that task based on subsequent data received as an input and processed by the machine-learning model. The machine learning model is an example of, or includes aspects of, the corresponding element described with reference to FIGS. 2, 7, and 11.

### Evaluation and Implementation

An exemplary embodiment of the present disclosure is configured to implement a multi-modal pretraining and a supervised fine-tuning method for LLaVA-1.5. In some examples, the rewards and responses are generated using an identical visual backbone and large language models (LLMs) such as, but not limited to, Mistral-7B, Llama3-8B, and Vicuna-7B. In some examples, each of the language generation model is trained on BLIP-LAION-CC-SBU-558k dataset for the multi-modal pre-training and on LL aVA-NexT-instruct-1M dataset for the supervised fine-tuning. In some cases, the image and the prompt used for generation of the data are randomly sampled from Cambrian-7M dataset.

In each iteration, the language processing apparatus is configured to ensure a minimum number of samples after performing rejection sampling. In some cases, each iteration includes different samples. For example, the iterative training is conducted over three iterations based on complete fine-tuning on 8 A 100 80 GB GPUs. In some examples, the preference data (i.e., evaluation data) is collected in 80 hours. In some examples, a self-improvement process of the language generation models of the panel-of-peers model is performed in 10 hours.

An exemplary embodiment of the present disclosure is configured to evaluate responses generated by each language generation model of the panel-of-peers model. In some cases, the language processing apparatus is configured to generate a detailed prompt template that enables each language generation model to rate the response generated by each of the other language generation models of the panel-of-peers model. In some cases, the detailed prompt template is used to generate a pseudo-reward. For example, the pseudo-reward is used to provide a feedback signal to enable iterations of the peer-to-peer learning. Each language generation model of the panel-of-peers model is configured to evaluate an output of each of the other language generation models in the panel-of-peers model based on a set of predefined criteria. In some cases, the pseudo-reward is aggregated using an ensemble method.

According to an embodiment, the detailed prompt template comprises a system prompt, an evaluation criteria, and a rating guideline. For example, the system prompt enables a language generation model of the panel-of-peers model as an expert evaluator. In some examples, the expert evaluator is configured to assess the quality of a response provided to a query (e.g., a user query). In some examples, the question and a corresponding image are provided for context.

For example, the evaluation criteria enables the model (i.e., expert evaluator) to evaluate the received response based on characteristics (characteristics such as including, but not limited to, helpfulness, correctness, coherence, complexity, and verbosity) on an ordinal Likert scale. In some examples, helpfulness refers to utility of the received response in addressing the user query on a scale of 1 to 5. In some examples, correctness refers to accuracy and factuality of the response on a scale of 1 to 5. In some examples, coherence refers to logical consistency and clarity of the response on a scale of 1 to 5. In some examples, complexity refers to a level of language sophistication, i.e., ranging from simple-level to expert-level on a scale of 1 to 5. In some examples, verbosity refers to appropriateness of detail and conciseness on a scale of 1 to 5.

For example, the rating guidelines refers to detailed explanations received by the model (i.e., expert evaluator) for scoring each dimension. In some examples, a helpfulness rating of 5 indicates complete alignment with the user intent. In some examples, a helpfulness rating of 1 indicates failure to address the query (e.g., the user query) effectively. Similarly, in some examples, a coherence rating of 5 indicates high logical flow in the generated response. In some examples, a coherence rating of 1 indicates substantial contradictions or redundancy.

According to an embodiment, each language generation model of the panel-of-peers model is instructed to provide an evaluation in a JSON schema format including scores for each criterion. The detailed prompt enables consistent and systematic evaluation of the responses generated by each language generation model of the panel-of-peers model. In some cases, by performing the systematic and consistent evaluation, embodiments of the present disclosure ensure the pseudo-rewards are aligned with the evaluation criteria.

Embodiments of the present disclosure are configured to evaluate an efficacy of panel-of-peers model learning across a benchmarking metric. For example, the language processing apparatus of the present disclosure is able to consistently outperform existing preference alignment methods.

According to an embodiment of the present disclosure, the language processing apparatus implements a peer-assessment process that significantly enhances quality of a response provided by each language generation model of the panel-of-peers model. For instance, the language processing apparatus is configured to aggregate a judgment across the language generation models which results in an ensemble that is more accurate than an individual language generation model.

The language processing apparatus of the present disclosure is able to consistently enhance a performance of each language generation model of the panel-of-peers model. In some cases, the language processing apparatus is configured to achieve increasingly high average scores based on performing multiple iterations. In some examples, each language generation model of the panel-of-peers model is able to achieve consistently high reward scores based on a Best-of-N sampling method.

An exemplary embodiment of the present disclosure is configured to evaluate an OCR capability. The language processing apparatus is able to evaluate the OCR capability of each language generation model of the panel-of-peers model. In some examples, the OCR capability is used for reading-specific tasks and for tasks with an understanding of structured visual data or answering knowledge-based questions involving text. For example, the language processing apparatus enhances hallucination detection and vision-centric tasks for each language generation model of the panel-of-peers model resulting in increased alignment in multimodal understanding.

According to an exemplary embodiment, a set of language generation models in panel-of-peer model learning combines diversity, unbiased evaluation, and iterative feedback. Embodiments of the present disclosure are configured to implement an alignment objective based on a supervised fine-tuning (SFT) method. In some examples, the language processing apparatus of the present disclosure is configured to generate data

$$𝒟 = {\{ ( I , x , {y}^{( m )} , {y}^{( 0 )} ) \}}_{i = 1}^{\vert 𝒟 \vert}$$

with distinct positive and negative feedback for the models. For example, the language processing apparatus uses the generated data for training each language generation model of the panel-of-peers model using the SFT method.

For example, in case of relative scoring, the language processing apparatus is configured to provide for each language generation model to evaluate the response simultaneously. In case of relative scoring, the language processing apparatus assigns a relative score or ranking to each language generation model, which is aggregated by averaging. For example, in case of absolute scoring, the language processing apparatus is configured to evaluate each language generation model individually (i.e., without comparisons).

An exemplary embodiment of the present disclosure is configured to identify an optimal combination of the evaluation provided by the language generation models of the panel-of-peers model. In some cases, the optimal combination is identified based on a PoP-MEAN method that refers to an averaging of reward scores across panel members. In some cases, the optimal combination is identified based on a PoP-MIN method that selects a minimum score which ensures that at least one language generation model of the panel-of-peers model perceives the response as sufficiently accurate to pass. In some cases, the optimal combination is identified based on a PoP-UW (uncertainty-weighted) method that incorporates an uncertainty-aware mechanism. For example, the uncertainty-aware mechanism weights scores based on inter-model variance while adjusting for potential inconsistencies in panel evaluations.

### Computing Device

Embodiments of the present disclosure are configured to perform a panel-of-peer learning for enhancing self-improvement in a language generation model. For instance, the language generation model is a large vision-language model (LVLM) as described with reference to FIGS. 5-9. In some cases, the self-improvement of the LVLMs is enhanced by generating synthetic preference data. According to an embodiment, the panel-of-peer learning is used as an ensemble method during inference.

By using each model of the panel-of-peers as an evaluator as well as a response generator for synthetic data generation, embodiments of the present disclosure are able to iteratively refine the knowledge of each language generation model of the panel-of-peers model. Additionally, by implementing the language generation models of the panel-of-peers model with more refined knowledge based on the iterative process, embodiments are able to enhance quality and performance of the language generation models using a single inference step (i.e., instead of a plurality of steps).

FIG. 11 shows an example of a computing device according to aspects of the present disclosure. The computing device 1100 may be an example of the language processing apparatus 1200 described with reference to FIG. 12. In one aspect, computing device 1100 includes processor(s) 1105, memory subsystem 1110, communication interface 1115, I/O interface 1120, user interface component(s) 1125, and channel 1130.

In some embodiments, computing device 1100 is an example of, or includes aspects of, the panel-of-peers model of FIG. 12. In some embodiments, computing device 1100 includes one or more processors 1105 that can execute instructions stored in memory subsystem 1110 to perform media generation.

According to some aspects, computing device 1100 includes one or more processors 1105. In some cases, a processor is an intelligent hardware device, (e.g., a general-purpose processing component, a digital signal processor (DSP), a central processing unit (CPU), a graphics processing unit (GPU), a microcontroller, an application specific integrated circuit (A SIC), a field programmable gate array (FPGA), a programmable logic device, a discrete gate or transistor logic component, a discrete hardware component, or a combination thereof. In some cases, a processor is configured to operate a memory array using a memory controller. In other cases, a memory controller is integrated into a processor. In some cases, a processor is configured to execute computer-readable instructions stored in a memory to perform various functions. In some embodiments, a processor includes special purpose components for modem processing, baseband processing, digital signal processing, or transmission processing.

According to some aspects, memory subsystem 1110 includes one or more memory devices. Examples of a memory device include random access memory (RAM), read-only memory (ROM), or a hard disk. Examples of memory devices include solid state memory and a hard disk drive. In some examples, memory is used to store computer-readable, computer-executable software including instructions that, when executed, cause a processor to perform various functions described herein. In some cases, the memory contains, among other things, a basic input/output system (BIOS) which controls basic hardware or software operation such as the interaction with peripheral components or devices. In some cases, a memory controller operates memory cells. For example, the memory controller can include a row decoder, column decoder, or both. In some cases, memory cells within a memory store information in the form of a logical state.

According to some aspects, communication interface 1115 operates at a boundary between communicating entities (such as computing device 1100, one or more user devices, a cloud, and one or more databases) and channel 1130 and can record and process communications. In some cases, communication interface 1115 is provided to enable a processing system coupled to a transceiver (e.g., a transmitter and/or a receiver). In some examples, the transceiver is configured to transmit (or send) and receive signals for a communications device via an antenna.

According to some aspects, I/O interface 1120 is controlled by an I/O controller to manage input and output signals for computing device 1100. In some cases, I/O interface 1120 manages peripherals not integrated into computing device 1100. In some cases, I/O interface 1120 represents a physical connection or port to an external peripheral. In some cases, the I/O controller uses an operating system such as iOS®, ANDROID®, MS-DOS®, MS-WINDOWS®, OS/2®, UNIX®, LINUX®, or other known operating system. In some cases, the I/O controller represents or interacts with a modem, a keyboard, a mouse, a touchscreen, or a similar device. In some cases, the I/O controller is implemented as a component of a processor. In some cases, a user interacts with a device via I/O interface 1120 or via hardware components controlled by the I/O controller.

According to some aspects, user interface component(s) 1125 enable a user to interact with computing device 1100. In some cases, user interface component(s) 1125 include an audio device, such as an external speaker system, an external display device such as a display screen, an input device (e.g., a remote-control device interfaced with a user interface directly or through the I/O controller), or a combination thereof. In some cases, user interface component(s) 1125 include a GUI.

FIG. 12 shows an example of a language processing apparatus 1200 according to aspects of the present disclosure. Language processing apparatus 1200 is an example of, or includes aspects of, the corresponding element described with reference to FIGS. 1 and 3.

According to some aspects, language processing apparatus 1200 obtains a dataset including an input prompt. In some aspects, the input prompt includes an image and a query about the image. In some aspects, the dataset includes a set of input prompts corresponding to a set of different training tasks. According to some aspects, language processing apparatus 1200 obtains a dataset including an input prompt including an image and a query about the image.

In one aspect, language processing apparatus 1200 includes processor unit 1205, memory unit 1210, I/O module 1220, and training component 1225. In one aspect, memory unit 1210 includes panel-of-peers model 1215. Training component 1225 updates parameters of the panel-of-peers model 1215 stored in memory unit 1210. In some examples, the training component 1225 is located outside the language processing apparatus 1200.

Processor unit 1205 includes one or more processors. A processor is an intelligent hardware device, such as a general-purpose processing component, a digital signal processor (DSP), a central processing unit (CPU), a graphics processing unit (GPU), a microcontroller, an application specific integrated circuit (A SIC), a field programmable gate array (FPGA), a programmable logic device, a discrete gate or transistor logic component, a discrete hardware component, or any combination thereof.

In some cases, processor unit 1205 is configured to operate a memory array using a memory controller. In other cases, a memory controller is integrated into processor unit 1205. In some cases, processor unit 1205 is configured to execute computer-readable instructions stored in memory unit 1210 to perform various functions. In some aspects, processor unit 1205 includes special purpose components for modem processing, baseband processing, digital signal processing, or transmission processing. According to some aspects, processor unit 1205 comprises one or more processors described with reference to FIG. 11.

Memory unit 1210 includes one or more memory devices. Examples of a memory device include random access memory (RAM), read-only memory (ROM), or a hard disk. Examples of memory devices include solid state memory and a hard disk drive. In some examples, memory is used to store computer-readable, computer-executable software including instructions that, when executed, cause at least one processor of processor unit 1205 to perform various functions described herein.

In some cases, memory unit 1210 includes a basic input/output system (BIOS) that controls basic hardware or software operations, such as an interaction with peripheral components or devices. In some cases, memory unit 1210 includes a memory controller that operates memory cells of memory unit 1210. For example, the memory controller may include a row decoder, column decoder, or both. In some cases, memory cells within memory unit 1210 store information in the form of a logical state. According to some aspects, memory unit 1210 is an example of the memory subsystem 1110 described with reference to FIG. 11.

According to some aspects, language processing apparatus 1200 uses one or more processors of processor unit 1205 to execute instructions stored in memory unit 1210 to perform functions described herein. For example, the language processing apparatus 1200 may obtain a dataset including an input prompt; generate, using a panel-of-peers model, response data based on the input prompt, wherein the response data includes a first response generated by a first language generation model of the panel-of-peers model and a second response generated by a second language generation model of the panel-of-peers model that is different from the first language generation model; generate, using the panel-of-peers model, evaluation data based on the response data, wherein the evaluation data includes a first evaluation of the first response and a second evaluation of the second response, wherein the first evaluation is generated by the second language generation model and the second evaluation is generated by the first language generation model; and train the panel-of-peers model based on the evaluation data.

In one aspect, memory unit 1210 includes panel-of-peers model 1215 trained to obtain a dataset including an input prompt; generate, using a panel-of-peers model, response data based on the input prompt, wherein the response data includes a first response generated by a first language generation model of the panel-of-peers model and a second response generated by a second language generation model of the panel-of-peers model that is different from the first language generation model; generate, using the panel-of-peers model, evaluation data based on the response data, wherein the evaluation data includes a first evaluation of the first response and a second evaluation of the second response, wherein the first evaluation is generated by the second language generation model and the second evaluation is generated by the first language generation model; and train the panel-of-peers model based on the evaluation data.

For example, after training, the panel-of-peers model 1215 may perform inferencing operations as described with reference to FIGS. 1-4 to obtain a dataset including an input prompt; generate, using a panel-of-peers model, response data based on the input prompt, wherein the response data includes a first response generated by a first language generation model of the panel-of-peers model and a second response generated by a second language generation model of the panel-of-peers model that is different from the first language generation model; generate, using the panel-of-peers model, evaluation data based on the response data, wherein the evaluation data includes a first evaluation of the first response and a second evaluation of the second response, wherein the first evaluation is generated by the second language generation model and the second evaluation is generated by the first language generation model; and train the panel-of-peers model based on the evaluation data.

In some embodiments, the panel-of-peers model 1215 is an Artificial neural network (ANN) comprising a plurality of networks including the vision-language model described with reference to FIG. 6 and the transformer model described with reference to FIG. 7. An ANN can be a hardware component or a software component that includes connected nodes (i.e., artificial neurons) that loosely correspond to the neurons in a human brain. Each connection, or edge, transmits a signal from one node to another (like the physical synapses in a brain). When a node receives a signal, it processes the signal and then transmits the processed signal to other connected nodes.

ANNs have numerous parameters, including weights and biases associated with each neuron in the network, which control the degree of connection between neurons and influence the neural network's ability to capture complex patterns in data. These parameters, also known as model parameters or model weights, are variables that determine the behavior and characteristics of a machine learning model.

In some cases, the signals between nodes comprise real numbers, and the output of each node is computed by a function of its inputs. For example, nodes may determine their output using other mathematical algorithms, such as selecting the max from the inputs as the output, or any other suitable algorithm for activating the node. Each node and edge are associated with one or more node weights that determine how the signal is processed and transmitted. In some cases, nodes have a threshold below which a signal is not transmitted at all. In some examples, the nodes are aggregated into layers.

The parameters of panel-of-peers model 1215 can be organized into layers. Different layers perform different transformations on their inputs. The initial layer is known as the input layer and the last layer is known as the output layer. In some cases, signals traverse certain layers multiple times. A hidden (or intermediate) layer includes hidden nodes and is located between an input layer and an output layer. Hidden layers perform nonlinear transformations of inputs entered into the network. Each hidden layer is trained to produce a defined output that contributes to a joint output of the output layer of the ANN. Hidden representations are machine-readable data representations of an input that are learned from hidden layers of the ANN and are produced by the output layer. As the understanding of the ANN of the input improves as the ANN is trained, the hidden representation is progressively differentiated from earlier iterations.

Training component 1225 may train the panel-of-peers model 1215. For example, parameters of the panel-of-peers model 1215 can be learned or estimated from training data and then used to make predictions or perform tasks based on learned patterns and relationships in the data. In some examples, the parameters are adjusted during the training process to minimize a loss function or maximize a performance metric (e.g., as described with reference to FIG. 10). The goal of the training process may be to find optimal values for the parameters that allow the language generation model to make accurate predictions or perform well on the given task.

Accordingly, the node weights can be adjusted to improve the accuracy of the output (i.e., by minimizing a loss which corresponds in some way to the difference between the current result and the target result). The weight of an edge increases or decreases the strength of the signal transmitted between nodes. For example, during the training process, an algorithm adjusts machine learning parameters to minimize an error or loss between predicted outputs and actual targets according to optimization techniques like gradient descent, stochastic gradient descent, or other optimization algorithms. Once the machine learning parameters are learned from the training data, the panel-of-peers model 1215 can be used to make predictions on new, unseen data (i.e., during inference). Panel-of-peers model 1215 is an example of, or includes aspects of, the corresponding element described with reference to FIGS. 5 and 9.

According to some aspects, panel-of-peers model 1215 generates response data based on the input prompt, where the response data includes a first response generated by a first language generation model of the panel-of-peers model 1215 and a second response generated by a second language generation model of the panel-of-peers model 1215 that is different from the first language generation model. In some examples, panel-of-peers model 1215 generates evaluation data based on the response data, where the evaluation data includes a first evaluation of the first response and a second evaluation of the second response, where the first evaluation is generated by the second language generation model and the second evaluation is generated by the first language generation model.

In some aspects, the evaluation data includes a set of evaluation parameters including a helpfulness parameter, a correctness parameter, a verbosity parameter, a coherence parameter, a complexity parameter, or any combination thereof. In some examples, panel-of-peers model 1215 computes a first aggregate reward score for the first response and a second aggregate reward score for the second response based on the evaluation data. In some examples, panel-of-peers model 1215 generates text using the first language generation model based on the training. In some aspects, the panel-of-peers model 1215 includes a set of large vision-language models. In some aspects, each of the panel-of-peers model 1215 includes a different network architecture.

I/O module 1220 receives inputs from and transmits outputs of the language processing apparatus 1200 to other devices or users. For example, I/O module 1220 receives inputs for the panel-of-peers model 1215 and transmits outputs of the panel-of-peers model 1215. According to some aspects, I/O module 1220 is an example of the I/O interface 1120 described with reference to FIG. 11.

According to some aspects, training component 1225 trains the panel-of-peers model 1215 based on the evaluation data. In some examples, training component 1225 selects the first response as a training response based on the evaluation data, wherein the panel-of-peers model 1215 are trained based on the first response. In some aspects, training the panel-of-peers model 1215 comprises: iteratively training the panel-of-peers model 1215 based on a plurality of input prompts in the dataset.

According to some aspects, training component 1225 trains the panel-of-peers model 1215 to respond to the query about the image based on the response data. In some aspects, training component 1225 selects the first response as a training response based on the evaluation data, wherein the panel-of-peers model 1215 is trained based on the first response. In some aspects, training component 1225 iteratively trains the panel-of-peers model 1215 based on a plurality of input prompts in the dataset.

The description and drawings described herein represent example configurations and do not represent all the implementations within the scope of the claims. For example, the operations and steps may be rearranged, combined or otherwise modified. Also, structures and devices may be represented in the form of block diagrams to represent the relationship between components and avoid obscuring the described concepts. Similar components or features may have the same name but may have different reference numbers corresponding to different figures.

Some modifications to the disclosure may be readily apparent to those skilled in the art, and the principles defined herein may be applied to other variations without departing from the scope of the disclosure. Thus, the disclosure is not limited to the examples and designs described herein but is to be accorded the broadest scope consistent with the principles and novel features disclosed herein.

The described methods may be implemented or performed by devices that include a general-purpose processor, a digital signal processor (DSP), an application specific integrated circuit (A SIC), a field programmable gate array (FPGA) or other programmable logic device, discrete gate or transistor logic, discrete hardware components, or any combination thereof. A general-purpose processor may be a microprocessor, a conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Thus, the functions described herein may be implemented in hardware or software and may be executed by a processor, firmware, or any combination thereof. If implemented in software executed by a processor, the functions may be stored in the form of instructions or code on a computer-readable medium.

Computer-readable media includes both non-transitory computer storage media and communication media including any medium that facilitates transfer of code or data. A non-transitory storage medium may be any available medium that can be accessed by a computer. For example, non-transitory computer-readable media can comprise random access memory (RAM), read-only memory (ROM), electrically erasable programmable read-only memory (EEPROM), compact disk (CD) or other optical disk storage, magnetic disk storage, or any other non-transitory medium for carrying or storing data or code.

Also, connecting components may be properly termed computer-readable media. For example, if code or data is transmitted from a website, server, or other remote source using a coaxial cable, fiber optic cable, twisted pair, digital subscriber line (DSL), or wireless technology such as infrared, radio, or microwave signals, then the coaxial cable, fiber optic cable, twisted pair, DSL, or wireless technology are included in the definition of medium. Combinations of media are also included within the scope of computer-readable media.

In this disclosure and the following claims, the word “or” indicates an inclusive list such that, for example, the list of X, Y, or Z means X or Y or Z or XY or XZ or Y Z or XY Z. Also the phrase “based on” is not used to represent a closed set of conditions. For example, a step that is described as “based on condition A” may be based on both condition A and condition B. In other words, the phrase “based on” shall be construed to mean “based at least in part on.” Also, the words “a” or “an” indicate “at least one.”

What is claimed is:

1. A method of training a machine learning model, the method comprising:
obtaining a dataset including an input prompt;
generating, using a panel-of-peers model, response data based on the input prompt, wherein the response data includes a first response generated by a first language generation model of the panel-of-peers model and a second response generated by a second language generation model of the panel-of-peers model that is different from the first language generation model;
generating, using the panel-of-peers model, evaluation data based on the response data, wherein the evaluation data includes a first evaluation of the first response and a second evaluation of the second response, wherein the first evaluation is generated by the second language generation model and the second evaluation is generated by the first language generation model; and
training the panel-of-peers model based on the evaluation data.

2. The method of claim 1, wherein:
the input prompt comprises an image and a query about the image.

3. The method of claim 1, wherein:
the dataset includes a plurality of input prompts corresponding to a plurality of different training tasks.

4. The method of claim 1, wherein:
the evaluation data comprises a plurality of evaluation parameters including a helpfulness parameter, a correctness parameter, a verbosity parameter, a coherence parameter, a complexity parameter, or any combination thereof.

5. The method of claim 1, further comprising:
computing a first aggregate reward score for the first response and a second aggregate reward score for the second response based on the evaluation data.

6. The method of claim 1, further comprising:
selecting the first response as a training response based on the evaluation data, wherein the panel-of-peers model is trained based on the first response.

7. The method of claim 1, wherein training the panel-of-peers model comprises:
iteratively training the panel-of-peers model based on a plurality of input prompts in the dataset.

8. The method of claim 1, further comprising:
generating text using the first language generation model based on the training.

9. A non-transitory computer readable medium storing code for response generation, the code comprising instructions that, when executed by at least one processor, cause the at least one processor to perform operations comprising:
obtaining a dataset including an input prompt comprising an image and a query about the image;
generating, using a panel-of-peers model, response data based on the input prompt, wherein the response data includes a first response to the query generated by a first language generation model of the panel-of-peers model and a second response to the query generated by a second language generation model of the panel-of-peers model; and
training the panel-of-peers model to respond to the query about the image based on the response data.

10. The non-transitory computer readable medium of claim 9, wherein:
the dataset includes a plurality of input prompts corresponding to a plurality of different training tasks.

11. The non-transitory computer readable medium of claim 9, wherein:
an evaluation data comprises a plurality of evaluation parameters including a helpfulness parameter, a correctness parameter, a verbosity parameter, a coherence parameter, a complexity parameter, or any combination thereof.

12. The non-transitory computer readable medium of claim 9, the code further comprising instructions that, when executed by the at least one processor, cause the at least one processor to perform operations comprising:
computing a first aggregate reward score for the first response and a second aggregate reward score for the second response based on an evaluation data.

13. The non-transitory computer readable medium of claim 9, the code further comprising instructions that, when executed by the at least one processor, cause the at least one processor to perform operations comprising:
selecting the first response as a training response based on an evaluation data, wherein the panel-of-peers model is trained based on the first response.

14. The non-transitory computer readable medium of claim 9, the code further comprising instructions that, when executed by the at least one processor, cause the at least one processor to perform operations comprising:
iteratively training the panel-of-peers model based on a plurality of input prompts in the dataset.

15. The non-transitory computer readable medium of claim 9, the code further comprising instructions that, when executed by the at least one processor, cause the at least one processor to perform operations comprising:
generating text using the first language generation model based on the training.

16. A system comprising:
a memory component; and
a processing device coupled to the memory component, the processing device configured to perform operations comprising:
obtaining a dataset including an input prompt;
generating, using a panel-of-peers model, response data based on the input prompt, wherein the response data includes a first response generated by a first language generation model of the panel-of-peers model and a second response generated by a second language generation model of the panel-of-peers model that is different from the first language generation model;
generating, using the panel-of-peers model, evaluation data based on the response data, wherein the evaluation data includes a first evaluation of the first response and a second evaluation of the second response, wherein the first evaluation is generated by the second language generation model and the second evaluation is generated by the first language generation model; and
training the panel-of-peers model based on the evaluation data.

17. The system of claim 16, wherein:
the panel-of-peers model comprises a plurality of large vision-language models.

18. The system of claim 16, wherein:
each of the panel-of-peers model is pre-trained using a same training set.

19. The system of claim 16, wherein:
each of the panel-of-peers model comprises a different network architecture.

20. The system of claim 16, wherein:
each of the panel-of-peers model is iteratively updated based on the evaluation data.
